(19) United States
(12) Patent Application Publication
(10) Pub. No.: US 2026/0049434 A1
(43) Pub. Date: Feb. 19, 2026

(54) LAUNDRY MACHINE

(71) Applicant: LG ELECTRONICS INC., Seoul (KR)

(72) Inventors: Sunghwan BAE, Seoul (KR); Jihun KIM, Seoul (KR); Mingyu KIM, Seoul (KR)

(21) Appl. No.: 19/277,643

(22) Filed: Jul. 23, 2025

(30) Foreign Application Priority Data
Aug. 19, 2024 (KR) 10-2024-0110322
Aug. 19, 2024 (KR) 10-2024-0110329
Aug. 19, 2024 (KR) 10-2024-0110331

(51) Int. Cl. D06F 39/02; B01F 23/40; B01F 23/43; B01F 27/113; B01F 27/91; B01F 35/32; B01F 35/71; B01F 101/00; D06F 23/04; D06F 39/08

(52) U.S. Cl. CPC D06F 39/02; B01F 23/43; B01F 23/483; B01F 27/113; B01F 27/91; B01F 35/32015; B01F 35/712; B01F 35/7179; D06F 23/04; D06F 39/088; B01F 2101/4505

(57) ABSTRACT

A laundry machine according to an embodiment of the present invention, comprises: a cabinet; a tub rotatably disposed inside the cabinet; and a detergent supply device provided in the cabinet and supplying detergent to the tub, wherein the detergent supply device comprises: a housing mounted to the cabinet and connected to a water supply device; a drawer withdrawably mounted in the housing and having a receiving portion recessed for receiving the detergent; and a mixing member rotatably disposed in the receiving portion for mixing the detergent and eater, wherein the mixing member comprises: a rotating shaft that is the center of rotation of the mixing member; a plurality of blades extending radially from the rotating shaft; and an auxiliary blade extending from an end of the blade in a direction intersecting the blade.

### CROSS-REFERENCE TO RELATED APPLICATIONS

The present application claims the benefits of priorities to Korean Patent Application No. 10-2024-0110322, filed on Aug. 19, 2024, and Korean Patent Application No. 10-2024-0110329, filed on Aug. 19, 2024, and Korean Patent Application No. 10-2024-0110331, filed on Aug. 19, 2024, of which its incorporated herein by reference in its entirety.

### THE BACKGROUND

### 1. The Field

The present invention is related to a laundry machine.

### 2. Description of the Related Art

Generally, a laundry machine is a home appliance that performs washing operations by appropriately mixing detergent and washing water after the user puts laundry into the washing tub and enters the operation command.

Recent laundry machines are equipped with a detergent supply device that can use both solid and liquid detergents, and the detergent and washing water are supplied together into the washing tub according to the supply of washing water.
when powdered or solid detergent is loaded into the detergent supply device, if the temperature of the incoming washing water is low, the detergent may not dissolve properly and be supplied to the drum in clumps.

To address this issue, a laundry machine is being developed that includes a fan-shaped mixing member in the detergent supply device to dissolve powdered or solid detergent, and a structure where water is sprayed toward the mixing member to force it to rotate.

However, in laundry machines with this structure, there is a problem that the powdered detergent is scattered when the nozzle sprays water to rotate the mixing member, contaminating the detergent supply device or splashing outward.

In addition, there is a problem that the powdered detergent moves outward due to centrifugal force when the mixing member rotates, so the detergent is not dissolved, and there is a problem that the powdered detergent flows into the washing tub. This causes a serious problem that the washing quality deteriorates due to residual detergent.

In addition, there is a problem that the durability of the fan-shaped mixing member is weak due to the structure, causing damage to the blade or deformation and breakage of the mixing member. In particular, there is a problem that the possibility of damage to the mixing member is very high because frequent cleaning is required due to the characteristics of the usage environment of the detergent supply device.

### THE SUMMARY

The embodiment of the present invention aims to provide a laundry machine equipped in which washing quality is improved through effective dissolution of powdered detergent.

The embodiment of the present invention aims to provide a laundry machine that prevents detergent scattering and contamination of the detergent supply device.

The embodiment of the present invention aims to provide a laundry machine that reinforces the strength of a mixing member and prevents breakage.

A laundry machine according to an embodiment of the present invention may comprise: a cabinet; a tub rotatably disposed inside the cabinet; and a detergent supply device provided in the cabinet and supplying detergent to the tub, wherein the detergent supply device comprises: a housing mounted to the cabinet and connected to a water supply device; a drawer withdrawably mounted in the housing and having a receiving portion recessed for receiving the detergent; and a mixing member rotatably disposed in the receiving portion for mixing the detergent and eater, wherein the mixing member comprises: a rotating shaft that is the center of rotation of the mixing member; a plurality of blades extending radially from the rotating shaft; and an auxiliary blade extending from an end of the blade in a direction intersecting the blade.
the auxiliary blades may be formed on each of the blade.
the auxiliary blade may extend in a direction opposite to the rotational direction of the mixing member.
the auxiliary blade may extend in the circumferential direction of the mixing member.
the auxiliary blade may extend along one end of the blade far from the rotation axis and may extend upward from the lower end of the blade.
the auxiliary blade may be formed to be vertical or at an acute angle with respect to the bottom surface of the receiving portion.
the mixing member may include a ring connecting the extended ends of the plurality of blades.
the ring may connect the lower ends of the plurality of blades, and the auxiliary blade may extend from the blades along the ring.
the auxiliary blade may connect between one end of the blade farthest from the rotation axis and the upper end of the ring.
the auxiliary blade may be formed lower than the upper end of the blade.
the auxiliary blades may extend from the ring at the same height.
the extended length of the auxiliary blade may be formed smaller than the gap between the adjacent blades.
a nozzle may be provided on the inside of the housing to spray water supplied from the water supply device toward the blade to rotate the mixing member.
the blade may be formed to be inclined in the direction of rotation of the blade, so that an extension of the outlet of the nozzle and a surface of the blade may intersect each other.
a first set angle may be formed between the surface of the blade and the upper end of the auxiliary blade, and the first set angle may be an obtuse angle.
the mixing member may include a ring connecting the extended ends of the plurality of blades, and the lower portion of the auxiliary blade and the ring may be formed at a second set angle, and the second set angle may be formed to be greater than the first set angle.
the receiving portion may comprise: a round portion formed in a shape corresponding to the outer diameter of the mixing member and forming the front part of the receiving portion; and a side portion extending from both sides of the round portion to the rear end of the drawer and forming both sides of the receiving portion, and wherein the rear side of the receiving portion may be opened to the rear of the drawer.
a drainage groove may be formed on the bottom of the receiving portion, extending to the rear end of the drawer, through which the detergent of the receiving portion is discharged, and a rotating boss protruding upward may be provided on the inside of the drainage groove so that the rotating shaft can be rotatably installed.
the lower end of the rotating shaft may extend downwards further than the lower end of the blade and may be accommodated inside the drainage groove, and the blade may be positioned above the drainage groove.
the blade and the auxiliary blade may pass through the drainage groove when the mixing member rotates.

The following effects can be expected from the laundry machine according to the proposed embodiment.

According to an embodiment of the present invention, a laundry machine may be provided with an auxiliary blade at the end of a blade of a mixing member rotatably arranged in a receiving portion.

The auxiliary blade prevents powdered detergent moving in a circumferential direction along the blade from leaving the mixing member and guides it into the space between the blades, thereby facilitating mixing and dissolving the washing water and powdered detergent. Due to the effective dissolution of the powdered detergent, the washing quality can be improved by preventing the powdered detergent from remaining in the washing tub.

In particular, when washing water is sprayed to the blade through a nozzle for the rotation of the mixing member, the powdered detergent is covered so that it does not fly out of the mixing member, thereby preventing contamination of the drawer and detergent supply device and maintaining a clean state.

The auxiliary blade has a structure that extends in the opposite direction to the rotational direction of the mixing member and extends along a ring, thereby having a more solid structure, and its durability is improved, so that the mixing member is not damaged even when repeatedly used and detached.

In addition, the auxiliary blade has a structure connecting the end of the mixing member and the ring, thereby preventing the powder detergent from flying and coming off, and is structurally stable, thereby ensuring smooth operation of the mixing member.

In addition, the blade and the auxiliary blade have a shape inclined in the direction of rotation, so that a simple mold structure can be separated in a rotational manner to form the mixing member, thereby providing an advantage in easy manufacturing. In addition, since a plurality of cores are not used when forming the mixing member, the parting line is prevented from being formed on the surface of the blade, thereby improving the appearance of the mixing member.

### BRIEF DESCRIPTION OF THE DRAWINGS

FIG. 1 is an isometric view of a laundry machine according to an embodiment of the present invention.

FIG. 2 is a rear view of the laundry machine.

FIG. 3 is an isometric view of the upper frame showing the detergent supply device being pulled out.

FIG. 4 is an isometric view of the detergent supply device.

FIG. 5 is an exploded perspective view of the drawer separated from the housing of the detergent supply device as seen from the front.

FIG. 6 is an exploded perspective view showing the rear of the drawer when the drawer is separated from the housing.

FIG. 7 is an exploded perspective view of the detergent supply device.

FIG. 8 is a perspective view of the housing with the flow path member attached, viewed from the front lower side.

FIG. 9 is an exploded perspective view of the housing and flow path member, viewed from the top.

FIG. 10 is an exploded perspective view of the housing and flow path member, viewed from the bottom.

FIG. 11 is a plan view of the flow path member.

FIG. 12 is a sectional isometric view of FIG. 4 along line 12-12.

FIG. 13 is an exploded perspective view of the drawer, mixing member, and receiving portion cover separated, as viewed from above.

FIG. 14 is an exploded perspective view of the drawer, mixing member, and receiving portion cover separated, as viewed from below.

FIG. 15 is a partial perspective view showing the mixing member mounted on the receiving portion.

FIG. 16 is an exploded perspective view showing the mixing member separated from the receiving portion.

FIG. 17 is a sectional isometric view of FIG. 15 along line 17-17.

FIG. 18 is a perspective view of the mixing member.

FIG. 19 is a plan view of the mixing member.

FIG. 20 is a back view of the mixing member.

FIG. 21 is an enlarged view of part A of FIG. 20.

FIG. 22 is an enlarged perspective view of section A of FIG. 20.

FIG. 23 is a sectional isometric view of FIG. 19 along line 23-23.

FIG. 24 is a sectional isometric view of FIG. 18 along line 24-24.

FIG. 25 is a side view of the mixing member facing downward.

FIG. 26 is a side view of the mixing member facing upward.

FIG. 27 is an enlarged view of part B of FIG. 26.

FIG. 28 is a schematic drawing of a mold device for forming the mixed member.

FIG. 29 is a drawing showing the arrangement of nozzles and gates for injection of the mixed member.

FIG. 30 is a drawing showing the flow path of the washing water supplied by the detergent supply device.

FIG. 31 is a drawing showing the arrangement of the water supply ports connected to each receiving portion of the drawer.

FIG. 32 is a drawing showing the washing water being sprayed into the mixing member through the nozzle of the path member.

FIG. 33 is a drawing showing the washing water falling into the first receiving portion through the first shower hole of the path member.

FIG. 34 is a perspective view showing the flow of detergent inside the receiving portion.

FIG. 35 is an enlarged view of part B of FIG. 34.

FIG. 36 is a drawing showing the washing water falling into the second receiving portion through the second shower hole formed in the path member.

FIG. 37 is a drawing showing the washing water falling into the third receiving portion through the third shower hole formed in the path member.

### DETAILED DESCRIPTION

The following describes in detail specific embodiments of the present invention with reference to the accompanying drawings. However, the present invention is not limited to the embodiments in which the ideas of the present invention are presented, and other embodiments that fall within the scope of the ideas of the present invention can be easily proposed by adding, changing, or deleting other components.

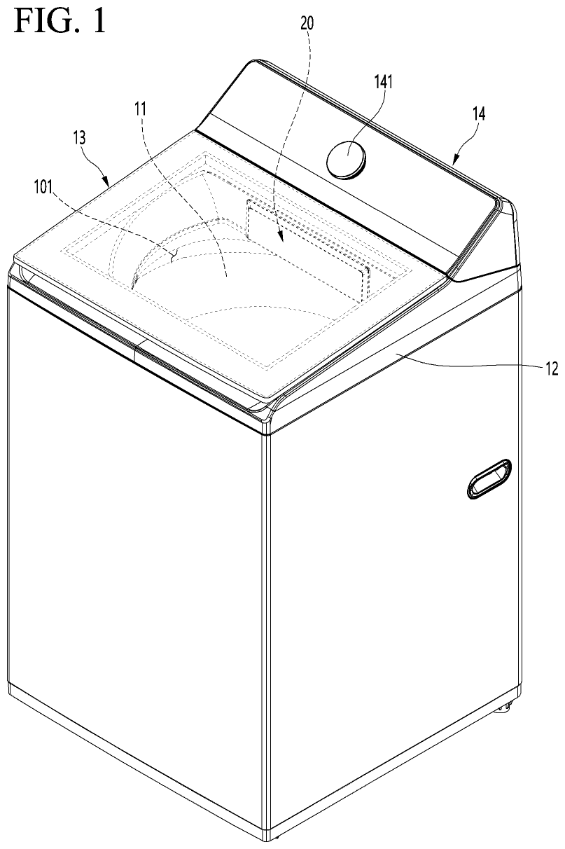

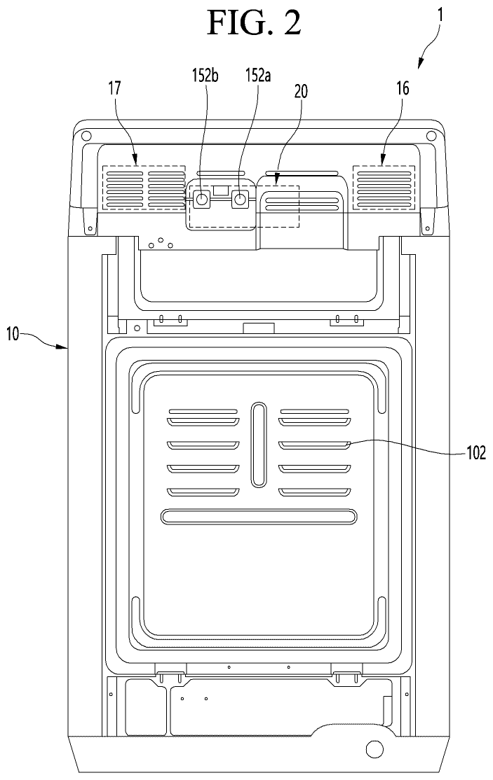

Before proceeding with the description, the directions are defined. In the embodiment of the present invention, with respect to a center point of the laundry machine shown in FIGS. 1 and 2, the direction toward the floor surface where the laundry machine is installed is defined as a downward direction; the direction toward the surface where the opening for the input port is formed in the cabinet is defined as an upward direction; the direction toward the surface where the back plate is installed is defined as a rearward direction; and the direction toward the surface opposite the rearward direction is defined as a forward direction. When referring to directions not explicitly defined, the directions can be defined and described based on each figure.

Furthermore, while the embodiment of the present invention is illustrated using an example of a top-loading type laundry machine with a door formed on the upper surface and laundry being loaded through the opened upper surface, the present invention is not limited to the structure and form of the laundry machine and is applicable to all forms of laundry machines equipped with a detergent supply device. For example, the present invention is applicable to various laundry machines, including drum laundry machines.

FIG. 1 is a perspective view of the laundry machine according to an embodiment of the present invention, and FIG. 2 is a rear view of the laundry machine.

Referring to FIGS. 1 and 2, the laundry machine 1 according to an embodiment of the present invention includes a cabinet 10, an upper frame 12 placed on the upper surface of the cabinet 10, a door 13 that is rotatably connected to the upper frame 12, and a control panel 14 mounted on the rear edge of the upper frame 12.

In detail, the cabinet 10 forms the exterior of the laundry machine 1 and can form a space for washing inside thereof.

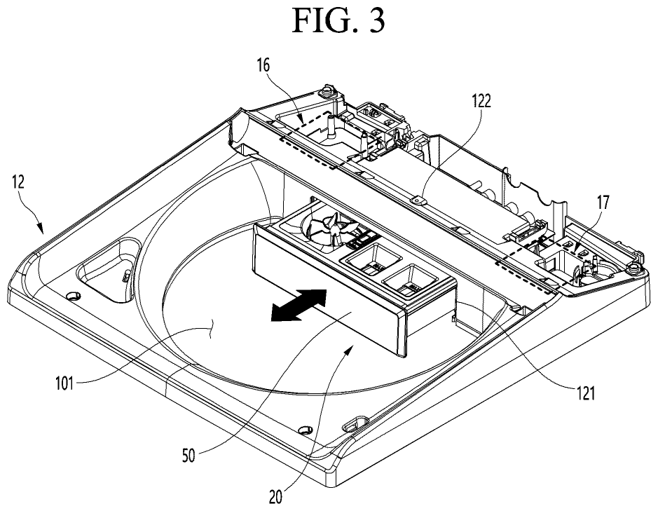

For example, the cabinet 10 may be formed in a hexahedral shape, with an open upper surface, and the upper frame 12 covers the open upper surface of the cabinet 10. Furthermore, the upper frame 12 includes an inlet 101 (See FIG. 3), and the door 13 opens and closes the inlet 101.

Furthermore, the interior of the cabinet 10 accommodates a tub 11 connected to the inlet 101. The upper surface of the tub 11 is open and communicates with the inlet 101, and the interior of the tub 11 may accommodate a washing drum for receiving laundry. The washing drum may include a cylindrical drum. Furthermore, the interior of the cabinet 10 may be equipped with a motor and other drive devices for driving the drum.

For example, the control panel 14 may be provided on the upper surface of the upper frame 12 corresponding to the rear side of the inlet 101. Furthermore, the control panel 14 may be equipped with operating members 141 for operating the laundry machine 1. For example, the operating members 141 may include a knob and buttons. Additionally, the control panel 14 may be further equipped with a display for indicating the operation of the laundry machine 1.

The rear end of the door 13 is pivotably connected to the upper frame 12, allowing the user to lift or lower the front end of the door 13 to open or close the inlet 101. Additionally, at least a portion of the door 13 may be formed to be see-through such as transparent or translucent. Therefore, the user can see the inside of the washing drum through the see-through part of the door 13.

Meanwhile, the rear of the cabinet 10 may be formed by a back cover 102. When the back cover 102 is separated or removed, the components installed inside the laundry machine 1 become accessible for maintenance. For example, when the back cover 102 is separated, the power supply device 16, the water level sensor 17, and water supply device 15 arranged on the control panel 14 can be replaced or repaired.

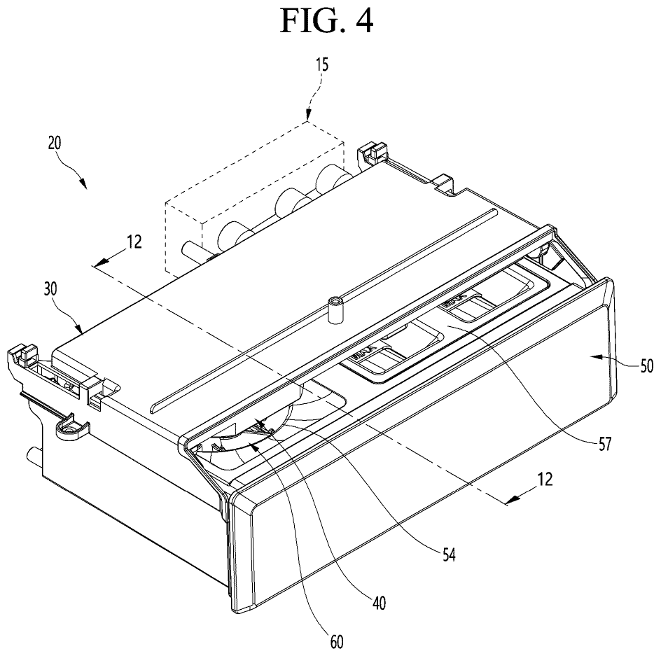

Additionally, the rear of the cabinet 10 may be equipped with a water supply pipe connection portion 152. The water supply pipe connection portion 152 may be connected to a water supply hose extending from an external water source. The water supply pipe connection portion 152 may be part of the water supply device 15 (See FIG. 4) described below. The water supply device 15 includes a plurality of valves and may be connected to a detergent supply device 20 arranged inside the cabinet 10. The water supply pipe connection portion 152 may include a hot water pipe connection portion 152a for supplying hot water and a cold water pipe connection portion 152b for supplying cold water. The water supply device 15 is described in more detail below with reference to the drawings.

The detergent supply device 20 may be provided on one side of the inlet 101, specifically on the rear side of the inlet 101. The detergent supply device 20 is configured to be withdrawable forward from the rear edge of the inlet 101, allowing the user to supply detergent into the detergent supply device 20. Furthermore, the detergent supply device 20 is connected to the water supply device 15, so that the detergent introduced into the detergent supply device 20 can be mixed with water supplied from the water supply device 15 and then supplied into the interior of the tub 11.

The following describes the detergent supply device 20 in more detail with reference to the drawings.

FIG. 3 is a perspective view of the upper frame showing the detergent supply device in the withdrawn state, FIG. 4 is a perspective view of the detergent supply device.

Referring to FIGS. 3 to 5, the upper frame 12 forming the inlet 101 is coupled to the upper surface of the cabinet 10

In detail, the upper frame 12 forms the upper part of the laundry machine 1, and the inlet 101 can be closed by the door 13. Additionally, the control panel 14 can be arranged on the rear side of the upper surface of the upper frame 12.

Furthermore, the detergent supply device 20 may be disposed on the upper frame 12. The detergent supply device 20 may be inserted into the frame opening 121 formed on one side of the inlet 101, specifically on the rear side of the inlet 101. Furthermore, the detergent supply device 20 is mounted inside the upper frame 12 through the frame opening 121. The detergent supply device 20 includes a housing 30 fixed inside the upper frame 12, a drawer 50 that can be pulled out and inserted into the housing 30, and a flow path member 40 that is connected to the housing 30 to form a flow path of water that is supplied to the drawer 50. Furthermore, in a state where the drawer 50 is closed, i.e., inserted into the interior of the housing 30, the front surface of the drawer 50 may form a portion of the rear surface of the inlet 101.

The detergent supply device 20 may be positioned at the lower central portion of the control panel 14. Furthermore, on the left and right edges of the control panel 14 corresponding to the left and right edges of the detergent supply device 20, a power supply device 16 for supplying power to drive the laundry machine 1 and a water level sensor 17 for detecting the water level in the tub 11 may be provided, respectively. Furthermore, a PCB may be arranged in the central portion of the control panel 14 corresponding to the upper side of the detergent supply device 20, which is electrically connected to various components including the operation unit arranged on the front of the control panel 14.

In addition, the water supply device 15 may be connected to the rear end of the detergent supply device 20. Furthermore, in a state where the detergent supply device 20 is installed, the water supply device 15 may be exposed externally from the rear of the laundry machine 1 and connected to a water supply pipe.

The water supply device 15 may be connected to the housing 30 of the detergent supply device 20. The water supply device 15 may include a plurality of valves for supplying water to the detergent supply device. In addition, the water supply device 15 includes a hot water pipe connection part 152a through which hot water is supplied and a cold water pipe connection part 152b through which cold water is supplied, and the hot water pipe connection part 152a and the cold water pipe connection part 152b may be exposed to the rear of the cabinet 10.

The water supply device 15 is connected to the rear of the housing 30, and the flow path member 40 is mounted on the upper surface inside the housing 30 to form a flow path communicating with the water supply device 15. Furthermore, the flow path member 40 is positioned above the drawer 50 in the state where the drawer 50 is closed. Therefore, water can fall from above the drawer 50 through the flow path member 40, and the falling water can be mixed with the detergent introduced into the drawer 50 and supplied to the tub 11.

For example, the drawer 50 may have a receiving portion 53. Specifically, the receiving portion 53 may include a first receiving portion 54, a second receiving portion 55, and a third receiving portion 56. Furthermore, the flow path member 40 may have independent flows directed toward each of the first receiving portion 54, second receiving portion 55, and third receiving portion 56. That is, by simply mounting a single flow path member 40 on the housing 30, it is possible to provide multiple flow paths that supply water to each of the multiple receiving portions 54, 55, 56 formed in the drawer 50.

Below, with reference to the drawings, the detailed structure of the housing 30, flow path member 40, and drawer 50 constituting the water supply device 15 will be described in detail.

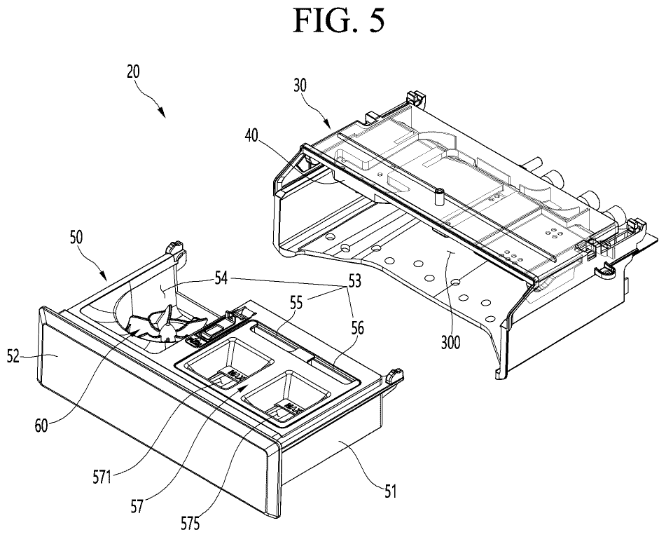

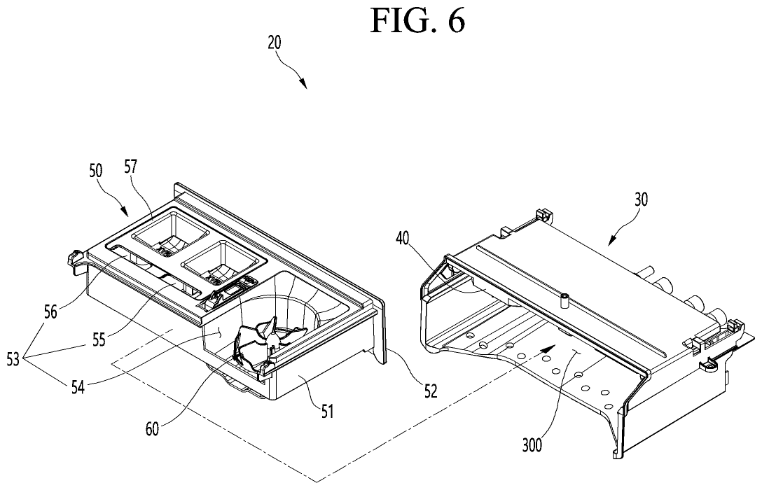

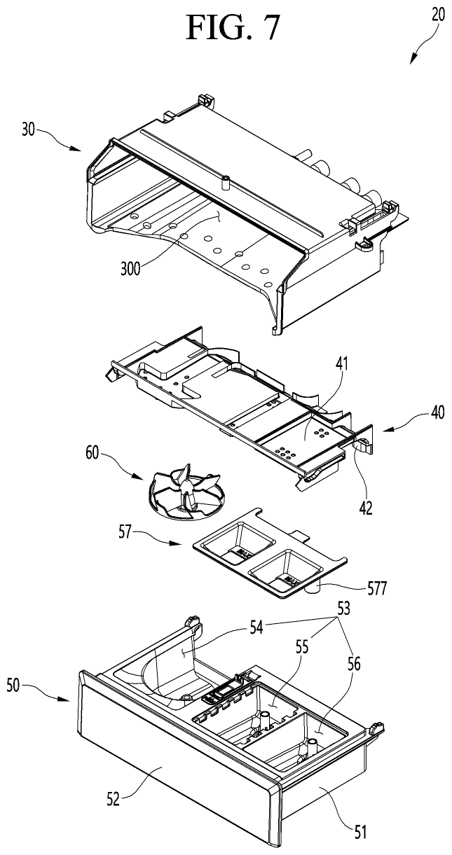

FIG. 5 is a front view of the housing of the detergent supply device with the drawer separated, FIG. 6 is a rear view of the drawer with the drawer separated from the housing, and FIG. 7 is an exploded view of the detergent supply device.

Referring to FIGS. 5 to 7, the housing 30 can be formed into a box-shaped structure with an open front, and can form a receiving space 300 that accommodates the flow path member 40 and the drawer 50 inside. For example, the housing 30 may be formed as a single piece by plastic injection molding.

The housing 30 may be connected to a water supply device 15 at the rear, and water supplied through the water supply device 15 may be supplied to the drawer 50 via the flow path member 40. For this purpose, the flow path member 40 can be coupled to the interior of the housing 30.

In detail, the flow path member 40 can be mounted on the upper surface of the interior of the housing 30. Furthermore, the flow path member 40 can have a plurality of flow passages formed with open upper surfaces. Therefore, when the flow path member 40 is mounted on the housing 30, one or more flow passages may be formed to supply water to the drawer 50 via the housing 30 and the flow path member 40. Furthermore, in a state where the flow path member 40 is mounted, the one or more flow passages may communicate with the water supply device 15.

The flow path member 40 may be positioned on the upper side of the drawer 50 when mounted on the housing 30. Furthermore, the front end of the flow path member 40 may extend to the front end of the upper surface of the housing 30. Therefore, water may fall toward the drawer 50 across the entire upper surface area of the receiving space 300.

The drawer 50 may be accommodated within the receiving space 300. The drawer 50 may be arranged so that it can be pulled out and pushed in through the open front of the housing 30. The drawer 50 may form a plurality of downwardly recessed receiving portions 53. The plurality of receiving portions 53 may be filled with detergent for washing.

For example, the receiving portions 53 may include a first receiving portion 54 for powder detergent, a second receiving portion 55 for liquid detergent, and a third receiving portion 56 for fabric softener. Of course, the second receiving portion 55 or the third receiving portion 56 may be omitted as needed.

The passages formed in the flow path member 40 may be formed on the upper side corresponding to the first receiving portion 54, the second receiving portion 55, and the third receiving portion 56. Furthermore, the water supplied from the water supply device 15 may be divided and supplied independently to the first receiving portion 54, the second receiving portion 55, and the third receiving portion 56.

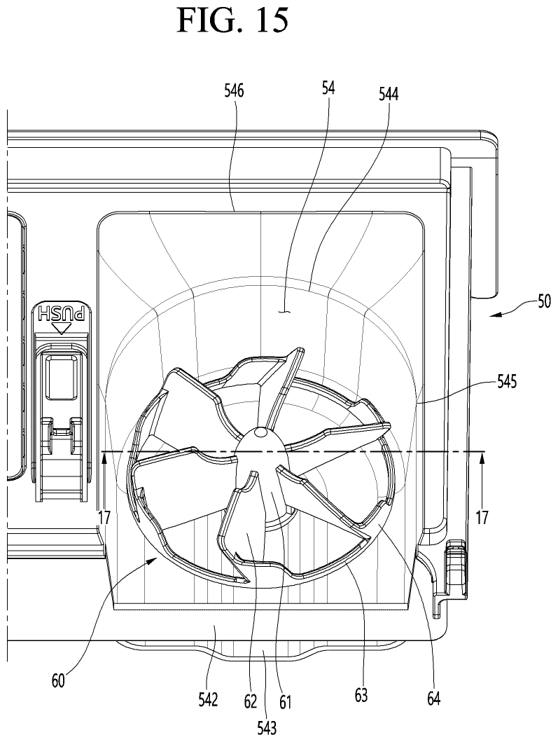

Meanwhile, a mixing member 60 may be provided inside the first receiving portion 54. The mixing member 60 may be formed in the shape of a fan or propeller having multiple blades. Furthermore, the mixing member 60 may be rotatably arranged in the first receiving portion 54. The mixing member 60 may be rotated by water sprayed from the nozzle 451 (See FIG. 15) formed in the flow path member 40. The mixing member 60 may be defined as a rotating member or mixing fan.

When washing water is supplied through the nozzle 451 in a state where powdered detergent is introduced into the first receiving portion 54, the mixing member 60 rotates to mix the washing water and the powdered detergent. The powdered detergent dissolved in the washing water can then be supplied to the tub 11 from the first receiving portion 54. For this purpose, at least a portion of the rear of the first receiving portion 54 can be opened.

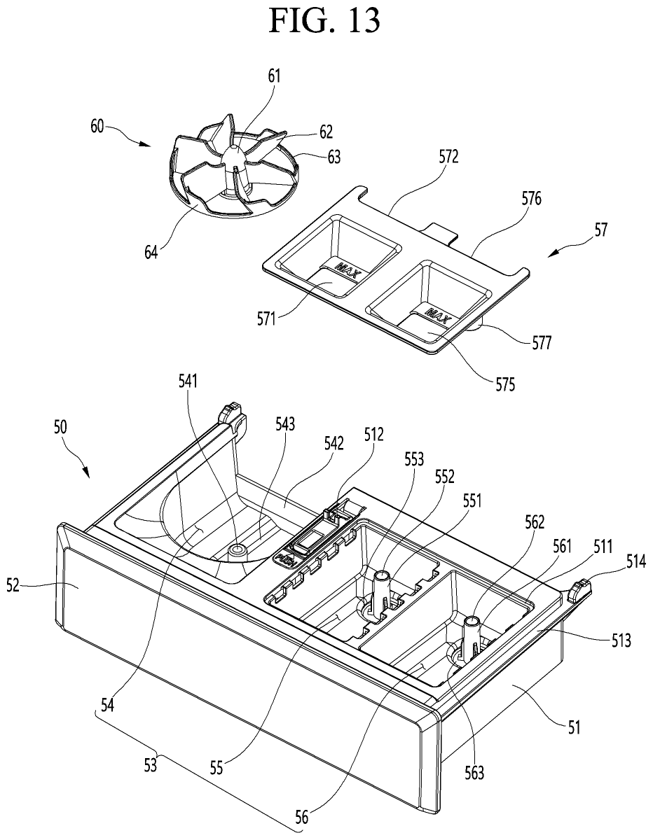

The second receiving portion 55 and third receiving portion 56 may be provided with a receiving portion cover 57. The receiving portion covers 57 may be placed on the open upper surfaces of the second receiving portion 55 and third receiving portion 56, and may be formed to slope downward along the concave shapes of the second receiving portion 55 and third receiving portion 56. Furthermore, cover holes 571, 572, 575, 576 (See FIG. 13) through which water falling from the flow path member 40 is supplied may be formed in the bottom portion of the recessed part of the receiving cover 57 formed with a downward slope and in the rear end of the receiving cover 57.

In this embodiment, the receiving portion cover 57 is presented in a manner that the recessed portions corresponding to the second receiving portion 55 and the third receiving portion 56 are formed as a single unit, but, it may also be provided as separate cover structures that shield the second receiving portion 55 and the third receiving portion 56 respectively.

The following describes the housing 30 in more detail with reference to the drawings.

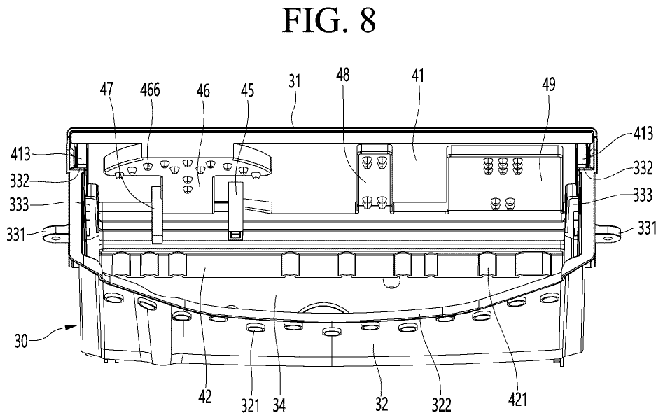

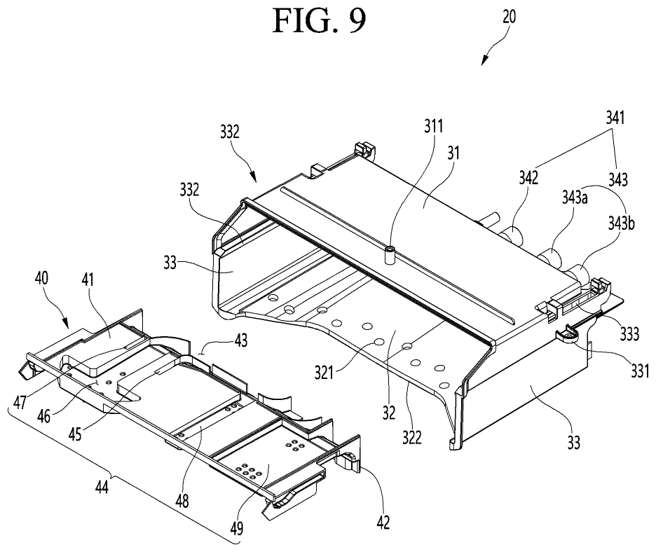

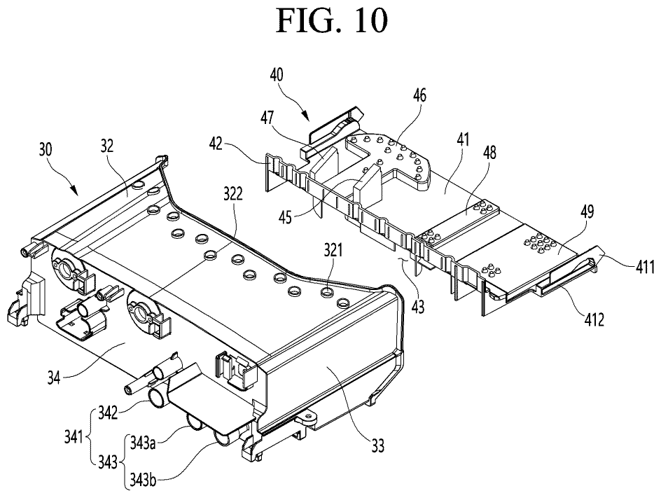

FIG. 8 is a perspective view of the housing with the flow path member attached, viewed from the front lower side, FIG. 9 is an exploded perspective view of the housing and flow path member, viewed from the top, and FIG. 10 is an exploded perspective view of the housing and flow path member, viewed from the bottom.

Referring to FIGS. 8 to 10, the housing 30 may be formed as a hexahedral shape with an open front surface and an accommodation space 300 thereinside. For example, the housing 30 may include a housing top surface 31, a housing bottom surface 32, a pair of housing side surfaces 33, and a housing rear surface 34.

The housing top surface 31 may have a housing mounting portion 311. The housing mounting portion 311 may be coupled to the upper frame 12. For example, the housing mounting portion 311 may include a boss to which a screw is fastened, and may be formed at a position corresponding to a frame coupling portion 122 (See FIG. 3) of the upper frame 12. Furthermore, a screw penetrating the frame coupling portion 122 is fastened to the housing mounting portion 311, thereby securing the housing 30 to the upper frame 12.

Additionally, a side mounting portion 331 may protrude from the outer surface of the housing side surface 33. In detail, the side mounting portion 331 protrudes laterally from the housing side surface 33, and a screw penetrating the side mounting portion 331 is connected to the upper frame 12, allowing the housing 30 to be securely fixed inside the upper frame 12.

The housing side surface 33 has a housing guide 332 formed in a stepped manner to guide the insertion and removal of the drawer 50, and the upper surface of the housing guide 332 accommodates the drawer guide 513 (See FIG. 13) formed on the drawer 50.

A drawer retaining portion 333 may be formed at the rear end of the housing side surface 33. an elastic member is mounted on the drawer retaining portion 333, and the elastic member can press against the upper surface of a drawer retaining protrusion 514 (See FIG. 13) of the drawer 50 when the drawer 50 is fully inserted into the interior of the housing 30, thereby restricting the withdrawal of the drawer 50.

The housing bottom surface 32 may include a housing discharge port 321 that allows the washing water mixed with detergent from the drawer 50 to fall downward. The housing discharge port 321 may be arranged in a plurality in an area adjacent to the front end 322 of the housing bottom surface 32. Furthermore, the front end 322 of the housing bottom surface 32 may be formed in a shape that is rearwardly recessed.

The housing rear surface 34 may be equipped with the water supply device 15. Additionally, the housing rear surface 34 may have a connection port 341 that protrudes rearwardly. The connection port 341 may be connected to the water supply body 151. The connection port 341 may include a hot water port 342 and a cold water port 343. The cold water port 343 may include a first cold water port 343a and a second cold water port 343b. the hot water port 342, the first cold water port 343a, and the second cold water port 343b communicate with the distribution path 43 formed in the flow path member 40 when the flow path member 40 is installed.

The flow path member 40 may be formed to a size corresponding to the housing upper surface 31. For example, when the flow path member 40 is mounted on the housing upper surface 31, the front and rear ends of the flow path member 40 extend to the front and rear ends of the housing upper surface 31, and the left and right sides of the flow path member 40 may be formed to extend to the left and right sides of the housing upper surface 31.

Furthermore, the rear end of the flow path member 40 extends downward and may come into contact with the housing rear surface 34. Additionally, the rear surface of the flow path member 40 may be connected to the connection port 341 connected to the water supply device 15.

The flow path member 40 may include a distribution path 43 and a discharge path 44 for supplying water to the receiving portion 53. The discharge path 44 may be formed with a predetermined depth of recess and may form independent flow passages by a coupling of the housing 30. The following describes the structure and function of the flow path member 40 including the paths 43, 44 in more detail with reference to the drawings.

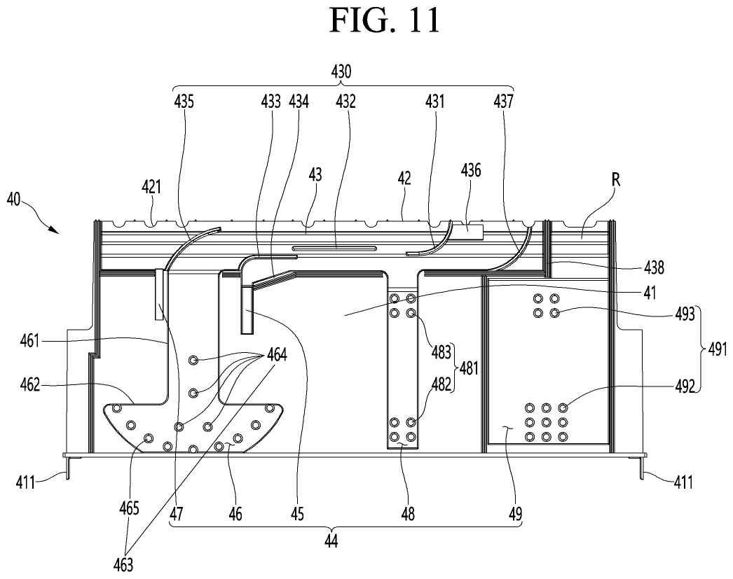

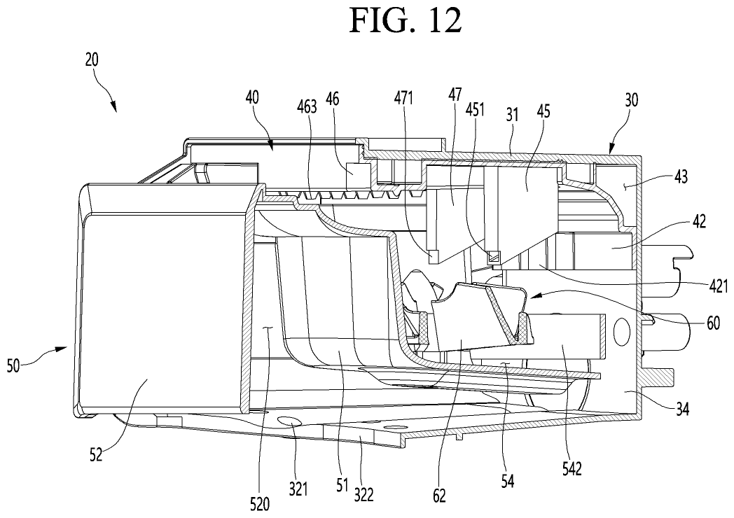

FIG. 11 is a plan view of the flow path member, FIG. 12 is a sectional isometric view of FIG. 4 along line 12-12.

Referring to FIGS. 11 and 12, the flow path member 40 may include an upper part 41, a rear part 42, and a corner part R where the rear end of the upper part 41 and the upper end of the rear part 42 meet. The upper part 41 may be defined as the surface facing the housing upper surface 31. A portion of the upper part 41 contacts the housing upper surface 31, while the other portion is recessed to form a flow path through which water supplied to the drawer 50 flows. That is, the open upper surfaces of the flow paths formed in the flow path member 40 can be shielded by the housing upper surface 31. The corner part R can be formed in a shape that is convexly rounded in a rearward direction.

The rear part 42 may extend downward from the rear end of the upper part 41. Furthermore, the rear part 42 may come into contact with the housing rear surface 30. Furthermore, the corner part R is spaced apart from the corner where the housing upper surface 31 and housing rear surface 34 meet, thereby forming a predetermined space between the rear surface of the flow path member 40 and the rear corner of the housing 30. The predetermined space can be defined as a washing water supply space and communicates with the connection port 341. Therefore, water supplied from the water supply device 15 to the housing 30 can be supplied to the upper part 41 via the washing water supply space. That is, the washing water discharged from the water supply device 15 and hitting the corner part R naturally flows toward the flow path formed in the upper part 41.

Meanwhile, the flow path may include a distribution path 43 and a discharge path 44. The discharge path 44 may supply water supplied from the distribution path 43 to the drawer 50.

For example, the discharge path 44 may include a first discharge path 45 that supplies water to the first receiving portion 54, and a second discharge path 46 and a third discharge path 47 that supply water to the mixing member 60. The distribution path 43 functions to divide and supply the water supplied from the water supply device 15 to the first to third discharge paths 45, 46, 47.

Furthermore, the discharge path 44 may further include a fourth discharge path 48 that supplies water to the second receiving portion 55.

Furthermore, the discharge path 44 may further include a fifth discharge path 49 that supplies water to the third receiving portion 56.

The distribution path 43 may extend laterally along the rear end of the flow path member 40. Furthermore, the distribution path 43 may distribute water to the first discharge path 45, the second discharge path 46, and the third discharge path 47. Furthermore, the distribution path 43 may also distribute water toward the fourth discharge path 48.

In detail, the distribution path 43 can be formed at the corner part R. Furthermore, the hot water port 342 and the cold water port 343 are connected to the distribution path 43, allowing hot water and cold water to be supplied to the distribution path 43. The hot water port 342 and the cold water port 343 may be positioned offset toward either the left or right edge of the distribution path 43. The hot water port 342 and cold water port 343 may be positioned closer to the first discharge path 45 than to the second discharge path 46.

Furthermore, the distribution path 43 may include a plurality of distribution ribs 430. The water flowing along the distribution path 43 is divided into the discharge paths 44 by the distribution ribs 430. The distribution path 43 can be understood as the flow path formed between the distribution rib formed at the far left and the distribution rib formed at the far right.

The distribution rib 430 may include a guide rib 437 that guides the water flowing into the flow path member 40 in one side direction. The guide rib 437 may be formed with a predetermined curvature or inclination to guide the water supplied from the cold water port 343 toward the left edge of the distribution path 43.

The distribution rib 430 may further include a first distribution rib 431 for guiding the flow of hot water and cold water. The first distribution rib 431 may be formed with a predetermined curvature at a point spaced apart from the guide rib 437 toward the left edge of the flow path member 40.

In detail, the first distribution rib 431 may extend to be rounded forward from the rear end of the distribution path 43, i.e., the rear end of the flow path member 40. The first distribution rib 431 may extend to the vicinity of the inlet of the fourth discharge path 48. Therefore, hot water and cold water may be guided along the first distribution rib 431. Furthermore, at least a portion of the supplied hot water and cold water can be mixed at the end of the first distribution rib 431 and guided toward the fourth discharge path 48. Furthermore, the remaining portion of the supplied hot water and cold water can be supplied to the first to third discharge paths 45, 46, 47 formed at the point where is offset to the left from the fourth discharge path 48.

Furthermore, an auxiliary rib 436 may extend horizontally and laterally from a side of the rear end of the first distribution rib 431 (the right side in FIG. 11). The auxiliary rib 436 may extend toward the cold water port 343, specifically the first cold water port 343a. Furthermore, the auxiliary rib 436 may extend from a point downwardly spaced apart from the upper end of the first distribution rib 431. Additionally, the front end of the auxiliary rib 436 may be extended forward to contact the corner part R. By forming the auxiliary rib 436, it is possible to prevent cold water introduced from the rear of the flow path member 40 from bypassing excessively downward.

The distribution rib 430 may include a second distribution rib 432 that guides the flow of hot water and cold water that has passed through the first distribution rib 431. The second distribution rib 432 may extend in a straight line for a predetermined length toward the left end of the flow path member 40 from a point where is spaced apart toward the left end of the flow path member 40 from the end of the first distribution rib 431. The second distribution rib 432 extends straight in the left-right direction, enabling the cold water and hot water passing through the first distribution rib 431 to maintain their straightness.

The distribution rib 430 may further include a third distribution rib 433 that guides water flowing toward the first discharge path 45 and the second discharge path 46. In detail, the third distribution rib 433 may extend between the first discharge path 45 and the second discharge path 46.

The third distribution rib 433 may extend rearward. Furthermore, the front portion of the third distribution rib 433 may be formed in a rounded shape, and the rear portion may extend parallel to the second distribution rib 432.

The distribution rib 430 may further include a fourth distribution rib 434. The fourth distribution rib 434 is a rib connecting the right side end of the inlet of the first discharge path 45 and the rear end of the upper part 41, and may be formed to slope forward from right to left. In detail, the left and right ends of the inlet of the first discharge path 45 may be connected to the third distribution rib 433 and the fourth distribution rib 434, respectively. Therefore, the washing water can be guided into the first discharge path 45 by the third distribution rib 433 and the fourth distribution rib 434.

The distribution path 43 may further include a fifth distribution rib 435. Specifically, the fifth distribution rib 435 may extend forward from the rear end of the corner part R and be positioned between the inlet of the second discharge path 46 and the inlet of the third discharge path 47. The fifth distribution rib 435 may extend toward the front in a rounded or sloped manner as it moves toward the left. Therefore, a portion of the washing water flowing past the second distribution rib 432 and the third distribution rib 433 to the left side of the flow member 40 can be guided to the third discharge path 47.

The left end of the distribution path 43 is defined by the left edge of the flow path member 40, and the right end thereof may be defined by a barrier 438. In detail, the barrier 438 extends from the rear end of the flow path member 40 to the front end of the corner part R and may be formed at a point spaced apart from the right end of the flow path member 40 toward the left.

Furthermore, the barrier 438 is connected to the left edge of the inlet of the fifth discharge path 49, and the right edge of the inlet of the fifth discharge path 49 may be defined by the right side of the flow path member 40. Furthermore, the second cold water port 343b is connected to the inlet of the fifth discharge path 49, enabling independent supply of cold water to the fifth discharge path 49.

Meanwhile, the inlet (or rear end) of the discharge path 44 communicates with the front end of the distribution path 43 and may be extended forward by a predetermined length. The discharge path 44 may be formed to be recessed or stepped downward by a predetermined depth from the upper surface of the upper part 41. Furthermore, the upper surface of the upper part 41 excluding the discharge path 44 contacts the lower surface of the housing upper surface 31. Therefore, the upper surface of the discharge path 44 is shielded by the coupling of the housing 30 and the path member 40, thereby completing an enclosed flow path.

The first to third discharge paths 45, 46, 47 are arranged within the space defined by the first receiving portion 54 when viewed from above the first receiving portion 54, and are provided to supply washing water to the first receiving portion 54.

In detail, the first discharge path 45 extends forward from the front end of the distribution path 43 toward the blades of the mixing member 60. That is, the first discharge passage 45 may extend toward a point spaced radially to the right of the rotational center of the mixing member 60. Furthermore, an open nozzle 451 may be formed at the front lower portion of the first discharge passage 45. The nozzle 451 may be opened toward the surface of the blade 62, and the opening shape of the nozzle 451 may be designed in various shapes.

Meanwhile, the lower surface of the first discharge path 45 may be inclined downward toward the cutting edge. Furthermore, the nozzle 451 may be opened at the front lower end of the first discharge path 45. Therefore, the water sprayed from the nozzle 451 strikes the surface of the blade 62 at a downward angle, causing the mixing member 60 to rotate. For example, the slope angle of the bottom surface of the first discharge path 45 may be set so that the washing water sprayed from the nozzle 451 and the surface of the blade 62 intersect perpendicularly. The nozzle 451 may be defined as the first nozzle 451.

Furthermore, the first discharge path 45 is located at a point radially spaced from the rotation axis 61 of the mixing member 60, so that the mixing member 60 rotates due to the moment generated by the washing water sprayed from the nozzle 451. Therefore, the farther the point where the water sprayed from the first nozzle 451 hits the blade surface of the mixing member 60 is from the rotation axis 61 of the mixing member 60, the faster the rotation speed of the mixing member 60 will be. Therefore, the extension position of the first nozzle 451 can be appropriately set according to the rotational speed of the mixing member 60 that optimizes the mixing of the washing water and detergent.

Since the first discharge path 45 only needs to provide sufficient flow rate to rotate the mixing member 60 at the set speed, the width of the first discharge path 45 can be designed to be narrower than that of the second discharge path 46.

The second discharge path 46 extends forward from the distribution path 43 and may extend through the center of the first receiving portion 54. Furthermore, the left edge of the second discharge path 46 may extend forward from the end of the fifth distribution rib 435. Furthermore, the second discharge path 46 may extend to the front end of the first receiving portion 54. Additionally, the second discharge path 46 may extend to the front end of the flow path member 40. Here, the first receiving portion 54 may be limited to the portion rounded along the circumferential surface of the mixing member 60. The recessed portion on upper end of the front side of the first receiving portion 54 may be understood as a guide portion formed to collect the scattered washing water into the first receiving portion 54.

The second discharge path 46 may be configured to allow water for dissolving the powdered detergent filled in the first receiving portion 54 and washing off the detergent adhering to the surface of the first receiving portion 54 to fall from the upper side of the first receiving portion 54. For this purpose, the second discharge path 46 may have a plurality of shower holes 463. The shower holes 463 are evenly arranged within the first receiving portion 54 to minimize the phenomenon of powdered detergent remaining inside the first receptacle 54. The shower holes 463 may be defined as first shower holes 463 to distinguish them from the second shower holes 481 and third shower holes 491 described below.

Furthermore, the second discharge path 46 may include a main portion 461 extending forward from the distribution path 43 and an extended portion 462 extending laterally from the front end of the main portion 461. That is, the main portion 461 may be designed to correspond to the body portion of the arrow, and the extended portion 462 may be designed to correspond to the head portion of the arrow.

Furthermore, the first shower hole 463 may be formed in a plurality along the main portion 461 and the extended portion 462. The first shower hole 463 may be formed to penetrate the flow path member 40 in the vertical direction. Furthermore, the first shower hole 463 is formed on a shower part 466, which is a nozzle-shaped protrusion extending downward from the lower surface of the flow path member 40. However, depending on the shape of the shower part 466 or the arrangement of the first shower hole 463, the first shower hole 463 may not penetrate the flow path member 40 vertically downward but may penetrate it at a downwardly inclined angle.

The main body 461 extends from the distribution path 43 and may further extend forward past the center of the mixing member 60. Furthermore, the extended portion 462 may extend from the front end of the main portion 461 to the front edge of the flow path member 40, and may extend in a form that expands to the left and right sides with respect to the main portion 461. At least a portion of the edge of the extended portion 462 may be formed with a curvature corresponding to the curvature of the front edge of the first receiving portion 54. The first shower hole 463 may be formed in the main portion 461 and the extended portion 462.

The first shower hole 463 may include a main shower hole 464 formed in the main part 461 and an extended shower hole 465 formed in the extended part 462. The main shower hole 464 may be provided in plurality and may be arranged at a position overlapping the mixing member 60 when viewed from above.

For example, the main shower hole 464 may be formed on a vertical line passing through the rotation axis 61 of the mixing member 60. Therefore, the washing water passing through the main shower hole 464 falls onto the tip of the rotation axis 61 and flows along the surface of the rotation axis 61, thereby washing off the powdered detergent adhering to the rotation axis 61. Furthermore, the main shower hole 464 may be further formed on the upper side of the blade 62 of the mixing member 60. Therefore, the washing water falling from the main shower hole 464 can wash off the powdered detergent adhering to the surface of the blade 62.

The extended shower holes 465 may be arranged in a spaced-apart manner along the front end of the extended portion 462. When viewed from above, the extended shower holes 465 may be located right above the rounded front surface of the first receiving portion 54. For example, since the front surface of the first receiving portion 54 is formed in a rounded shape, the plurality of extended shower holes 465 may also be arranged along a virtual arc line extending along the front surface of the first receiving portion 54. Additionally, one or more extended shower holes 465 may be further formed at the point between the edge of the blade 62 and the rotation axis 61. In this case, the position of the extended shower holes 465 may be formed at the point corresponding to a ring 63 of the mixing member 60. Therefore, the water falling from the main shower holes 464 can wash off the powdered detergent adhering to the blades 62, particularly the ring 63.

The third discharge path 47 is for washing powder detergent adhering to the surface of the blade 62 and may be arranged on the side of the second discharge path 46. Furthermore, the first discharge path 45 and the third discharge path 47 may be arranged side by side on opposite sides of the second discharge path 46. The surface (rear side) of the blade 62 where the washing water discharged from the third discharge path 47 strikes can be understood as the opposite side of the surface (front side) of the blade 62 where the washing water sprayed from the nozzle 451 of the first discharge path 45 strikes.

The third discharge path 47 may extend forward from the distribution path 43. The third discharge path 47 may be recessed into the upper part 41. Furthermore, the third discharge path 47 may extend to a position where it overlaps at least part of the mixing member 60 in the vertical direction when viewed from above. The third discharge path 47, like the first discharge path 45, may be formed with a downward slope toward the front.

A second nozzle 471 that sprays water in the opposite direction of the rotation of the mixing member 60 may be formed at the front lower end of the third discharge path 47. The second nozzle 471 may be formed at the lower end of the third discharge path 47. The water sprayed from the second nozzle 471 is directed toward the rear surface of the blade 62.

Meanwhile, the fourth discharge path 48 may be located on the upper side of the second receiving portion 55. The fourth discharge path 48 may extend forward from the distribution path 43. The fourth discharge path 48 may be recessed downward from the upper part 41. Furthermore, a plurality of second shower holes 481 may be formed in the fourth discharge path 48. The second shower holes 481 may open by passing through the fourth discharge path 48 and may be configured to allow water supplied to the fourth discharge path 48 to fall downward. The second shower holes 481 may include a plurality of first front holes 482 and a plurality of first rear holes 483.

The fifth discharge path 49 may be located above the third receiving portion 56. The fifth discharge path 49 may extend forward from the distribution passage 43. The fifth discharge path 49 communicates with an additional distribution path formed between the barrier 438 and the right side of the flow path member 40, and the width of the fifth discharge path 49 may be larger than the width of the additional distribution path. That is, the right side of the fifth discharge path 49 is defined by the right side of the flow path member 40, and the left side of the fifth discharge path 49 may be formed at a point spaced apart from the barrier 438 to the left.

The additional distribution path is positioned in front of the second cold water port 343b, and the washing water flowing into the second cold water port 343b is supplied to the fifth discharge path 49. Furthermore, the fifth discharge path 49 may extend forward beyond the center of the third receiving portion 56.

The fifth discharge path 49 may be recessed downward from the upper part 41. Furthermore, the fifth discharge path 49 may have a plurality of third shower holes 491 formed therein. The third shower holes 491 may be formed to open through the fifth discharge path 49 and may be configured to allow water supplied to the fifth discharge path 49 to fall downward.

The third shower holes 491 may include a plurality of second front holes 492 and a plurality of second rear holes 493.

Meanwhile, a plurality of drain portions 421 may be recessed on the rear surface of the rear part 42. when the water pressure from the water supply device 15 is high, some of the supplied water flows downward through the drain sections 421 to the rear side of the housing 30. By the plurality of drain portions 421, even if the pressure of the water supplied from the water supply device 15 suddenly increases, the phenomenon of water flowing back into the water supply device 15 or the water supply pipe connection portion 152 and causing leakage can be prevented.

Side guides 412 may be formed on both side ends of the flow path member 40. Furthermore, a side retaining portion 413 may protrude downward from the lower surface of the side guide 412. The side retaining portion 413 protrudes downward from the front end of the side guide 412, such that, when the drawer 50 is fully extended, the side retaining portion 413 interferes with a retaining protrusion 514 (See FIG. 13) formed on the drawer 50 to prevent the drawer 50 from separating.

Meanwhile, side walls 411 may be formed on both ends of the flow path member 40 corresponding to the bottom surface of the side guide 412. The side walls 411 extend downward from the outermost edge of the bottom surface of the side guide 412 and extend rearward for a predetermined length so that, when the flow path member 40 is mounted on the housing 30, the side walls 411 come into contact with the side surface of the housing 30. Therefore, the drawer guide 513 is positioned between the lower end of the side wall 411 and the upper surface of the housing guide 332.

Hereinafter, the drawer 50 will described in more detail with reference to the drawings.

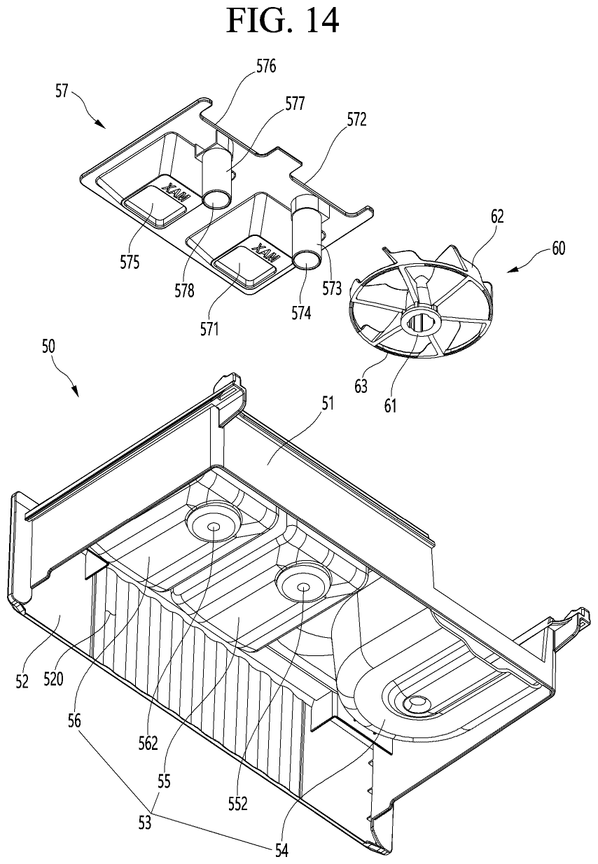

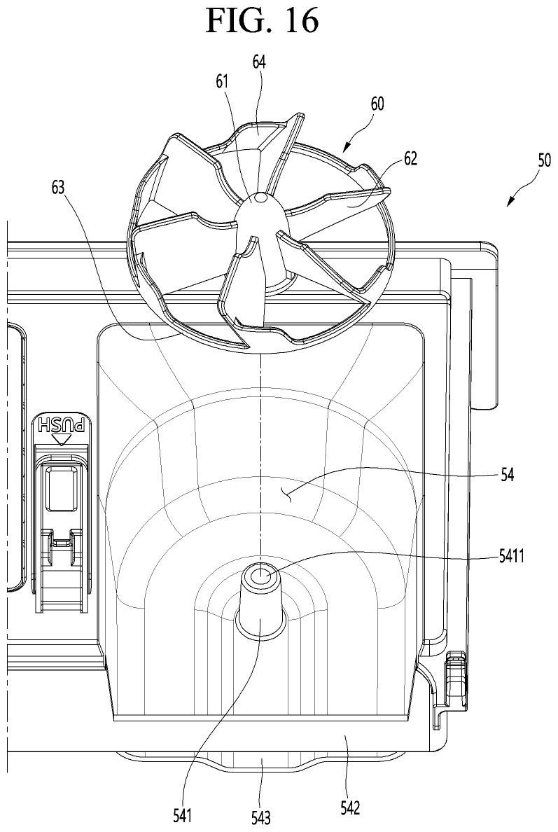

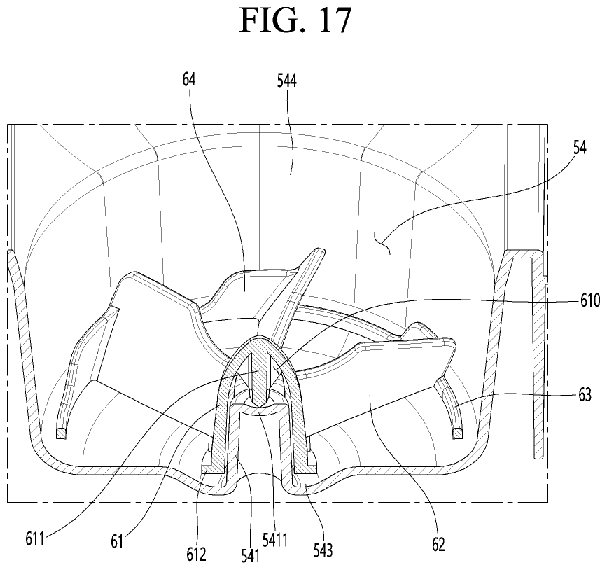

FIG. 13 is an exploded perspective view from above showing the drawer, mixing member, and receiving portion cover separated, FIG. 14 is an exploded perspective view from below showing the drawer, mixing member, and receiving portion cover separated, FIG. 15 is a partial perspective view showing the mixing member mounted on the receiving portion, FIG. 16 is an exploded perspective view showing the mixing member separated from the receiving portion, FIG. 17 is a sectional isometric view of FIG. 15 along line 17-17.

Referring to FIGS. 13 to 17, the drawer 50 is provided as a drawer with an open upper surface, which can be inserted into the receiving space of the housing 30 or pulled out forward from the receiving space.

In detail, the drawer 50 may include a drawer body 51 in which the receiving portion 53 is formed, and a drawer handle 52 formed on the front side of the drawer body 51. The drawer handle 52 may be formed to shield the frame opening 121 when the drawer 50 is inserted. Then, the drawer 50 may be withdrawn by inserting a finger into the back side of the drawer handle 52 and pulling the drawer handle 52 forward. To this end, an upwardly recessed handle groove 520 may be formed between the drawer front side 52 and the drawer body.

The upper surface of the drawer body 51 may have a recessed receiving portion 53. The receiving portion 53 may include a first receiving portion 54 in which the mixing member 60 is mounted. Furthermore, the receiving portion 53 may further include a second receiving portion 55 and a third receiving portion 56 arranged side by side next to the first receiving portion 54.

In the drawer body 51, a first receiving portion 54 may be recessed. In addition, a mixing member 60 may be provided in the first receiving portion 54. Powdered detergent and water may be contained in the first receiving portion 54, and by the rotation of the mixing member 60, the powdered detergent and water may be mixed to smoothly dissolve the powdered detergent. In addition, the dissolved powdered detergent and water may be discharged through the rear of the first receiving portion 54.

The drawer body 51 may further include a second receiving portion 55 and a third receiving portion 56. The second receiving portion 55 and the third receiving portion 56 may be arranged side by side next to the first receiving portion 54. The second receiving portion 55 and the third receiving portion 56 may have the same shape but different positions.

Hereinafter, the description is based on the shape of the second receiving portion 55, and the detailed description of the third receiving portion 56 is omitted. Of course, the second receiving portion 55 or the third receiving portion 56 may be omitted as necessary.

The second receiving portion 55 may have an open upper surface and be recessed downward. The open upper surface of the second receiving portion 55 may be formed in a rectangular shape. The bottom of the second receiving portion 55 may be formed with a slope that decreases toward the rear end. Furthermore, a siphon boss 551 that protrudes upward may be formed on the rear side of the bottom of the second receiving portion 55. An inner side of the siphon boss 551 may have a hollow space 552 that penetrates the siphon boss 551 in the vertical direction, allowing the detergent solution introduced into the second receiving portion 55 to be discharged below the drawer 50. Additionally, a siphon recess 553 may be formed at the lower edge of the siphon boss 551.

Furthermore, the drawer 50 may further include a receiving portion cover 57 placed on the second receiving portion 55. The receiving portion cover 57 may be formed as a single piece covering both the second receiving portion 55 and the third receiving portion 56, or it may consist of two separate covers.

The edges of the receiving portion cover 57 may be seated on the stepped portion 511 stepped along the upper edges of the second receiving portion 55 and the third receiving portion 56. Additionally, the lower surface of the receiving portion cover 57 may have a siphon extension portion 573 extending downward. The siphon extension portion 573 is formed in a tubular shape with an opening 574 on the bottom surface, so that when the receiving portion cover 57 is mounted on the second receiving portion 55, the siphon boss 551 can be inserted into the siphon extension portion 573.

Furthermore, the lower end of the siphon extension 537 can be seated in the siphon recess 553. Therefore, when water and detergent are supplied to the second receiving portion 55, the detergent mixture rises along the space formed between the outer surface of the siphon boss 551 and the inner surface of the siphon extension 537 and the detergent mixture can be discharged downward through the hollow portion 552 due to the siphon effect.

Meanwhile, the receiving portion cover 57 may have a first front cover hole 571 and a first rear cover hole 572. water falling from the second shower hole 481 above to pass through the first front cover hole 571.

The first front cover hole 571 is provided at the rear of the siphon extension 573. The first rear cover hole 572 is located directly below the second shower hole 481, and the washing water falling from the second shower hole 481 passes through the passage hole and fills the interior of the second receiving portion 55.

Meanwhile, the third receiving portion 56 may have a siphon boss 561 with a hollow portion 562 and a siphon recess 563. And, the receiving portion cover 57 may cover the third receiving portion 56. The receiving portion cover 57 may have a siphon extension portion 577 into which the siphon boss 561 is inserted. Furthermore, the receiving portion cover 57 may have a second front cover hole 575 and a second rear cover hole 576. The second front cover hole 575 and the second rear cover hole 576 may be formed with the same structure and shape as the first front cover hole 571 and the first rear cover hole 572 described above.
a latch portion 512 may be formed on the upper surface of the drawer body 51. Furthermore, the drawer guide 513 may extend longitudinally along the left and right sides of the drawer body 51. A locking protrusion 514 may be formed at the rear end of the drawer guide 513 and protrude upward.

Meanwhile, the mixing member 60 may be provided at the drawer 50. The mixing member 60 is provided in the first receiving portion 54, and can mix the powder detergent supplied into the first receiving portion 54 with water and then discharge it.

In detail, the first receiving portion 54 may be opened upward and backward, and may form a space in which the mixing member 60 is accommodated inside. The first receiving portion 54 may be formed to be recessed downward more than the height of the mixing member 60.

And, the first receiving portion 54 may include a round portion 544. The round portion 544 may form the front portion including the front end of the first receiving portion 54. The round portion 544 may form a rounded surface with a curvature corresponding to the outer diameter of the mixing member 60.

The round part 544 may be adjacent to the circumference of the mixing member 60. In particular, the round part 544 may be adjacent to the ring 63 and the auxiliary blade 64 of the mixing member 60. Therefore, when the mixing member 60 is mounted on the first receiving part 54, the inner surface of the first receiving part 54 and the mixing member 60 do not come into contact with each other, but most of the powdered detergent accommodated inside the first receiving part 54 may be mixed by the mixing member 60. Both ends of the round part 544 may be formed to extend to a position corresponding to the left and right ends of the outer diameter of the mixing member 60.

In addition, the first receiving part 54 may further include a side part 545. The side part 545 forms the left and right sides of the first receiving part 54 and may extend in parallel at a position facing each other. The side portion 545 may extend from the end of the round portion 544 to the rear end of the drawer 50. For example, the side portion 545 may be spaced apart by a distance equal to the distance between the rear ends of the round portions 544 and may extend perpendicularly to the rear end of the drawer 50.

And, the open rear surface of the first receiving portion 54 can be defined between the side parts 545 on both sides. Therefore, the dissolved powder detergent and water inside the first receiving portion 54 can be smoothly discharged to the open rear surface of the first receiving portion 54.

And, the first receiving portion 54 can further include a receiving portion guide 546. The receiving portion guide 546 can extend from the front of the round portion 544 to the rear end of the drawer 50. The receiving portion guide 546 is formed to receive the round portion 544 and the side parts 545, and can be recessed in the upper surface of the drawer body 51. In particular, the receiving portion guide 546 is formed to be inclined from the front of the round portion 544 toward the round portion 544 so that the washing water leaving the round portion 544 can flow back toward the round portion 544.

And, a rear plate 542 may be formed on the opened rear side of the first receiving portion 54. The rear plate 542 may be extended to connect the rear end of the side portion 545 at a point spaced upward from the bottom of the first receiving portion 54.

The rear plate 542 may prevent the powder detergent inside the first receiving portion 54 from being discharged all at once. And, the rear plate 542 may prevent the mixing member 60 from being separated from the outside of the first receiving portion 54. The rear plate 542 may be formed at a point closer to the bottom than the upper surface of the first receiving portion 54.

A drainage groove 543 may be formed in the center of the bottom surface of the first receiving portion 54. In addition, the remaining bottom surface of the first receiving portion 54 excluding the drainage groove 543 may be formed as a plane of the same height.

The drainage groove 543 may extend from a position corresponding to the center of the mixing member 60 to the rear end of the first receiving portion 54. The drainage groove 543 may be recessed to a predetermined depth. Therefore, the powdered detergent and water inside the first receiving portion 54 may be discharged along the drainage groove 543.

And, a rotating boss 541 on which the mixing member 60 is rotatably mounted may protrude inside the drainage groove 543. The rotating boss 541 may support the rotating shaft 61 in a rotatably manner inside the rotating shaft 61. For example, a support member 611 may protrude downward inside the rotating shaft 61, and the support member 611 may be seated in a shaft mounting member 5411 recessed into the upper end of the rotating boss 541. Accordingly, the mixing member 60) may rotate inside the first receiving portion 54 with the rotation boss 541 as the central axis.

The mixing member 60 is provided in a fan shape and can mix the powder detergent injected into the first receiving portion 54 with the washing water while rotating inside the first receiving portion 54. The mixing member 60 may include a rotating shaft 61 (or hub) mounted on the rotating boss 541 and a plurality of blades 62 extending from the rotating shaft 61. The mixing member 60 may be called a mixing fan, a propeller, or a screw. In addition, the mixing member 60 may further include an auxiliary blade 64. In addition, the mixing member 60 may further include a ring 63.

Hereinafter, the mixing member (60) will be described in more detail with reference to the drawings.

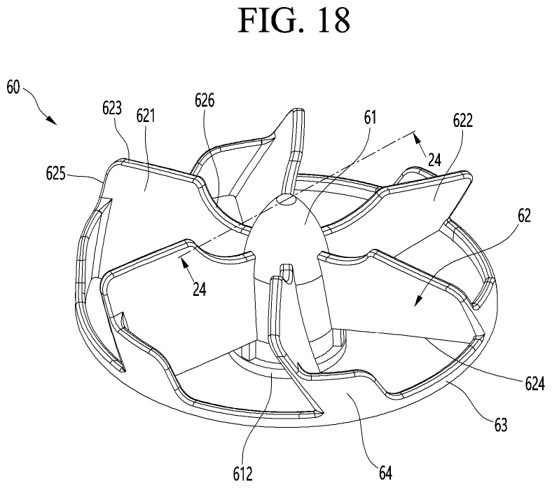

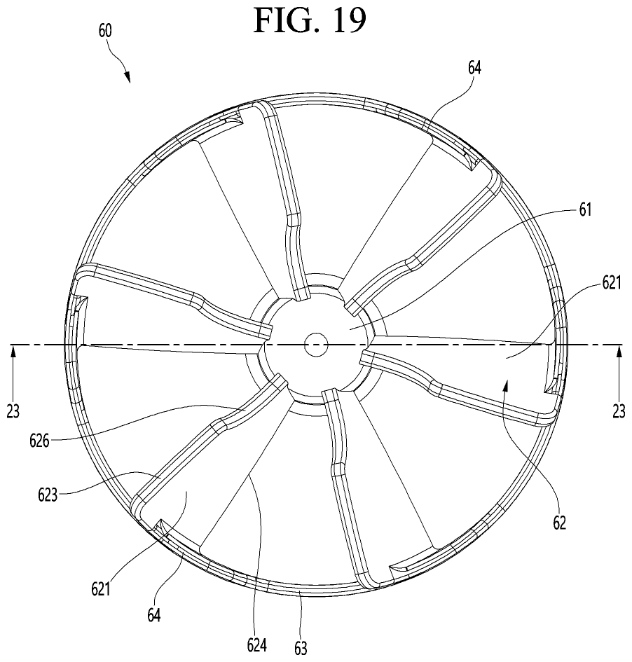

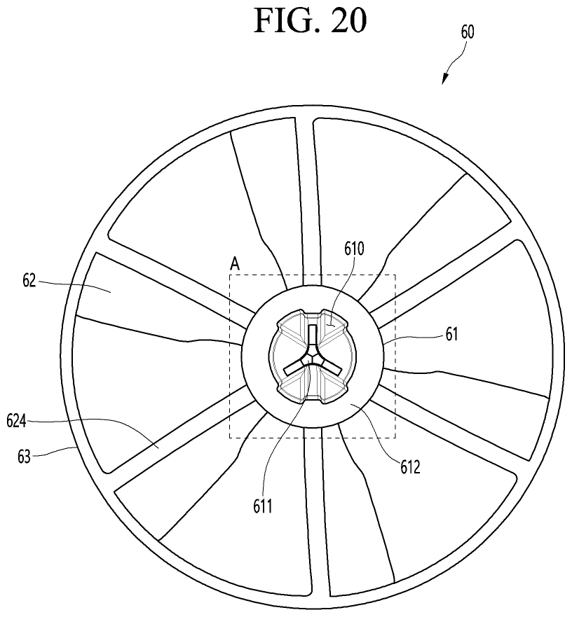

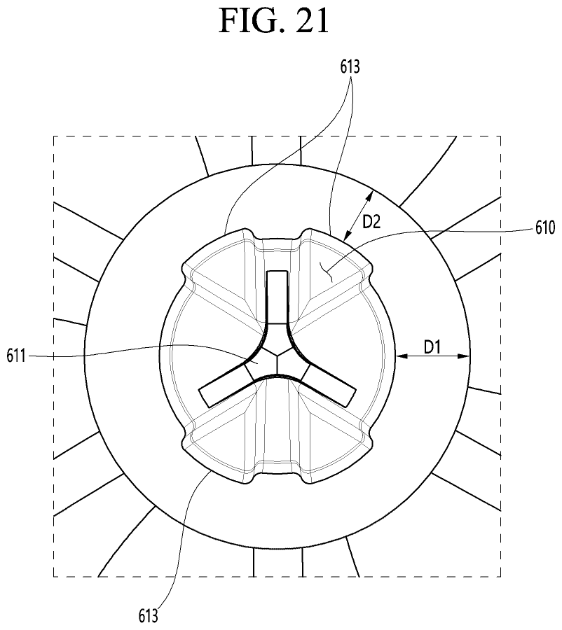

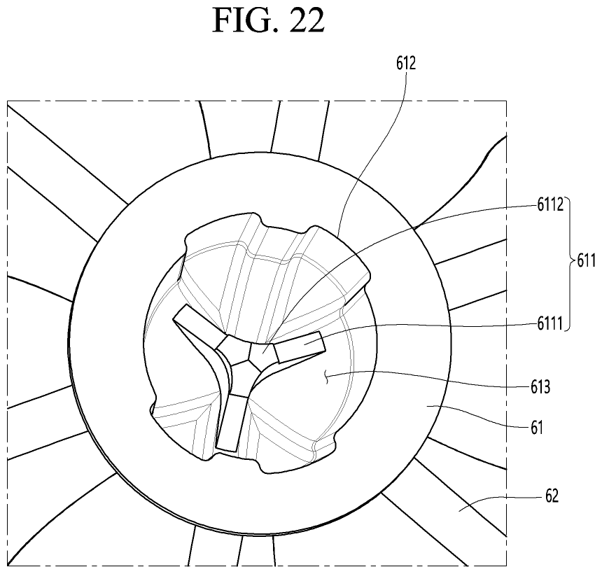

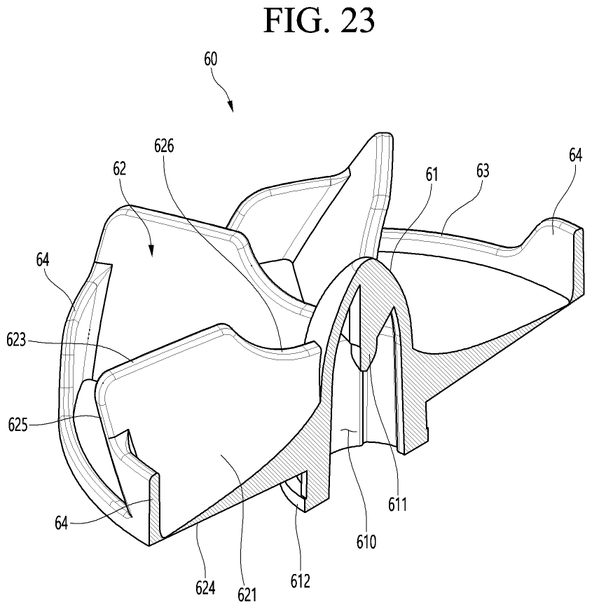

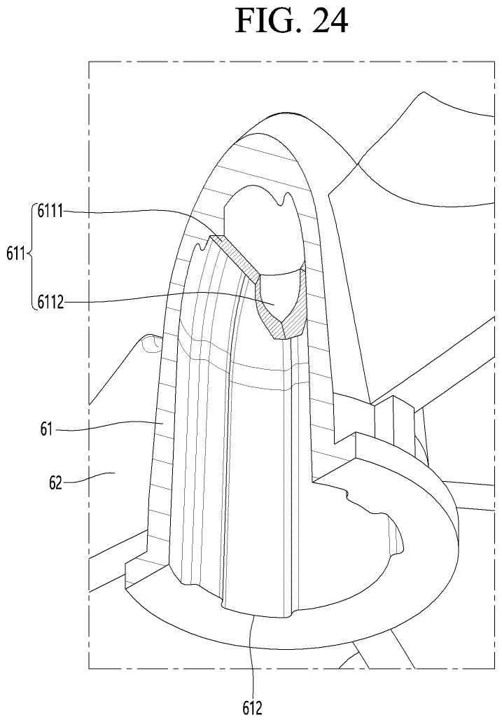

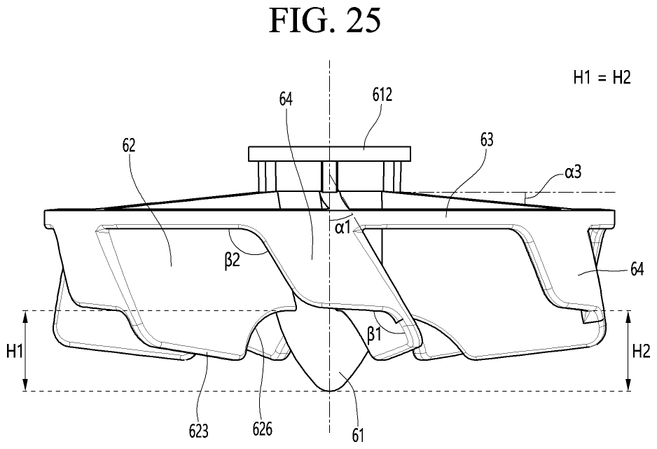

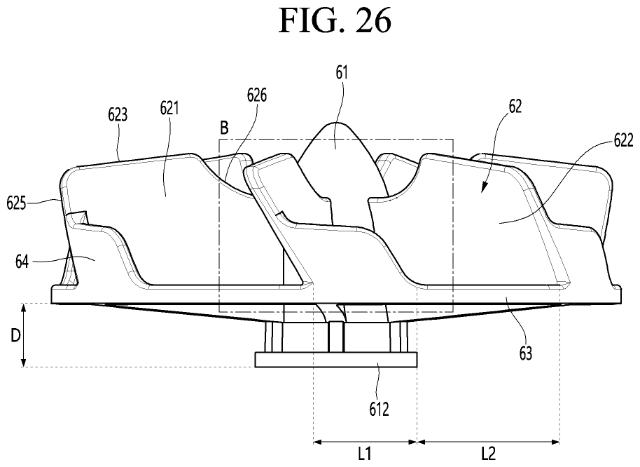

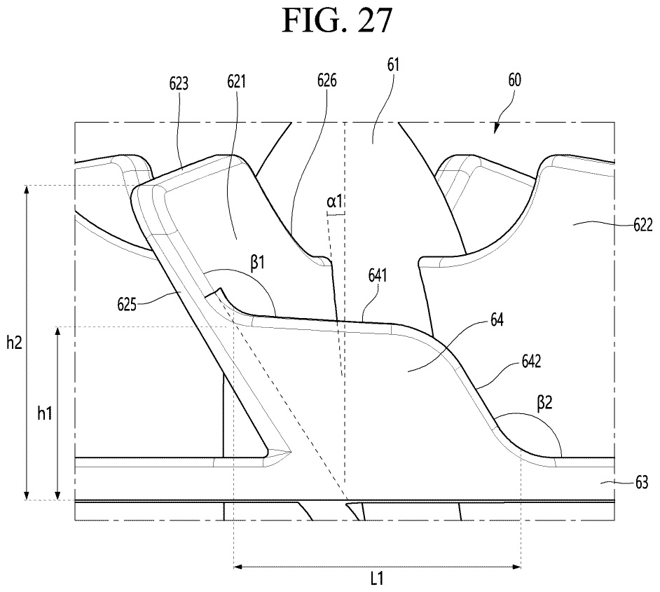

FIG. 18 is a perspective view of the mixing member, FIG. 19 is a plan view of the mixing member, FIG. 20 is a back view of the mixing member, FIG. 21 is an enlarged view of part A of FIG. 20, FIG. 22 is an enlarged perspective view of section A of FIG. 20, FIG. 23 is a sectional isometric view of FIG. 19 along line 23-23, FIG. 24 is a sectional isometric view of FIG. 18 along line 24-24, FIG. 25 is a side view of the mixing member facing downward, FIG. 26 is a side view of the mixing member facing upward, FIG. 27 is an enlarged view of part B of FIG. 26.

The rotating shaft 61 is formed at the center of the mixing member 60 and may serve as the rotational center of the mixing member 60. Additionally, the bottom of the rotating shaft 61 can be opened to form a space 610 into which the rotating boss 541 is inserted into the rotating shaft 61.

A support member 611 extending downwardly may be formed in the space 610 of the rotating shaft 61. The support member 611 may be formed in a shape that becomes narrower as it goes downward and may come into point contact with the shaft mounting portion 5411. Accordingly, the mixing member 60 may be made rotatable by water sprayed from the first nozzle 451.

A rotating shaft groove 613 may be formed on the inner surface of the rotating shaft 61. A plurality of rotating shaft grooves 613 may be formed along the circumference of the rotating shaft 61. By means of the rotating shaft groove 613, the flow of the resin injected during injection for molding the mixed member 60 can be improved, and the air trap point formed by the injection resin meeting can be moved to the parting line of the mold.

In detail, the rotating shaft groove 613 may extend upward from the opened lower surface of the rotating shaft 61. At this time, the rotating shaft groove 613 may extend upward from the protrusion 612. In addition, the rotating shaft groove 613 may extend along the extension direction of the rotating shaft 61, and may extend to the upper end of the inner surface of the rotating shaft 61 or to the position of the support member 611.

The rotating shaft 61 is formed so that its inner diameter becomes narrower as it extends from the bottom to the top, and the upper end of the rotating shaft 61 may be formed in a pointed shape. Accordingly, the rotating shaft groove 613 formed on the inner surface of the rotating shaft 61 may be formed so that its width becomes narrower as it extends upward.

And, the rotating shaft grooves 613 may be arranged radially in multiple numbers based on the center of the rotating shaft 61. At this time, the multiple rotating shaft grooves 613 may be arranged at same intervals. The rotating shaft grooves 613 may be arranged symmetrically based on the center of the rotating shaft 61. For example, the multiple rotating shaft grooves 613 may be arranged to correspond to both sides based on the support member 611. That is, the rotating shaft grooves 613 may be arranged two on each side facing each other based on the center of the support member 611. And, the rotating shaft grooves 613 may also be arranged spaced apart on both sides based on one extended side of the support member 611.

Meanwhile, by forming the rotating shaft groove 613, the circumference of the rotating shaft 61 can be formed to have different thicknesses depending on the section. In detail, the thickness (D2) of the circumference of the rotating shaft 61 where the rotating shaft groove 613 is formed can be formed smaller than the thickness (D1) of the circumference of the rotating shaft 61 where the rotating shaft groove 613 is not formed. For example, the thickness (D1) of the circumference of the rotating shaft 61 where the rotating shaft groove 613 is not formed can be formed to have a thickness of 2.5 mm. And, the thickness (D2) of the circumference of the rotating shaft 61 where the rotating shaft groove 613 is formed can be formed to have a thickness of 1.7 mm. That is, the circumference of the rotating shaft 61 can have variable thickness, and can have a thickness difference of 0.8 mm at the position where the rotating shaft groove 613 is located.

Meanwhile, the rotating shaft groove 613 is formed inside the rotating shaft 61, and the support member 611 extends from the upper end of the inner surface of the rotating shaft 61.

The support member 611 includes a support protrusion 6112 extending downward from the upper end of the rotating shaft 61 by a predetermined length, and a support base 6111 extending in a rib shape from the outer surface of the support protrusion 6112.

In detail, the lower end of the support base 6111 is formed sharply and is seated on the upper surface of the rotating boss 541. In addition, the support base 611 includes a plurality of support ribs arranged at a predetermined angle in the circumferential direction, and for example, three support ribs may be arranged at 120-degree intervals.

A plurality of air gaps 612 may be formed by being recess to a predetermined depth on the inner surface of the rotating shaft 61, and the plurality of air gaps 162 may be arranged at a predetermined interval in the circumferential direction. In addition, the air gaps 612 extend from the lower end to the upper end of the rotating shaft 61, so that air flowing into the inside of the rotating shaft groove 613 smoothly escapes to the outside of the rotating shaft 61 along the air gaps 612.

Meanwhile, the rotating shaft 61 may extend downward further than the blade 62. In addition, the protrusion 612 at the lower end of the rotating shaft 61 may be inserted into the drainage groove 543. The length (D) of the rotating shaft 61 protruding downward based on the blade 62 may correspond to the sinking depth of the drainage groove 543.

And, the protrusion 612 can protrude laterally from the circumference of the rotating shaft 61. And, an injection gate 69 connected to a nozzle 733 during injection molding of the maxing member 60 can be connected to the protrusion 612. That is, during injection molding of the maxing member 60, resin can be injected from the lower end of the rotating shaft 61 to mold the maxing member 60. Therefore, when the injection gate 69 is removed in a state where molding of the maxing member 60 is completed, exposure of the connection portion of the injection gate (69) can be minimized.

Accordingly, when molding the mixing member 60, the resin injected first fills the rotating shaft 61 through the injection gate 69, and at this time, the flowability of the resin is improved by the plurality of rotating shaft grooves 613, so that smooth flow of the resin toward the blade 62 can be guaranteed.

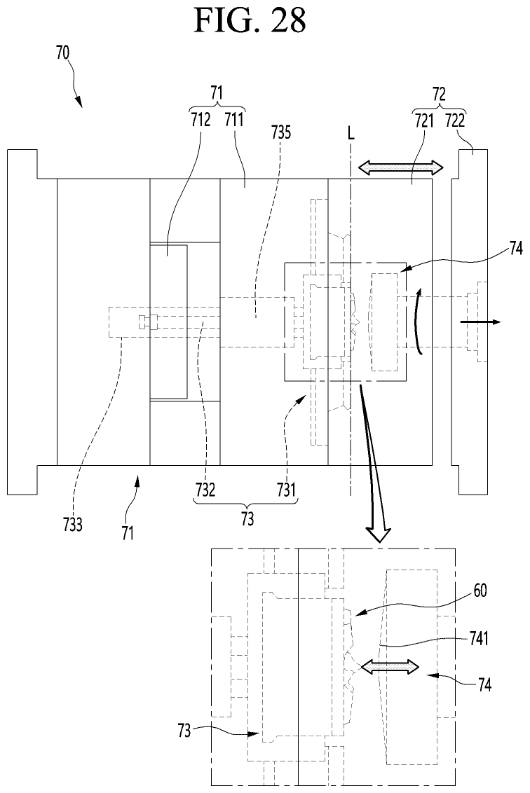

In addition, since the height (H2) of the upper end of the auxiliary blade 64 is formed to be the same as the height (H1) of the upper end of the blade 62 connected to the rotational axis, the cores (731, 74; see FIG. 28) of the mold device 70 that move up and down can have a dividing line (L; see FIG. 28) that separates them from each other positioned at the upper end of the blade 62 connected to the rotating shaft 61.

Accordingly, an air vent structure for exhaust can be applied at the dividing line (L), and the location of the air trap can be made at the dividing line (L), so that removal of the air trap through exhaust can be possible.

Meanwhile, the rotating shaft 61 may extend downward further than the blade 62. And, the lower end of the blade 62 may be inserted into the drainage groove 543. The length (D) of the rotation axis protruding downward based on the blade 62 may correspond to the sinking depth of the drainage groove 543.

Accordingly, when the mixing member 60 is mounted, the lower end of the blade 62 may be positioned on the bottom surface of the first receiving portion 54. Then, when the mixing member 60 rotates, the blade 62 can mix and move the powdered detergent inside the first receiving portion 54.

The blades 62 may be arranged radially around the circumference of the rotation axis 61. The blades 62 may be formed to be inclined with respect to the bottom of the first receiving portion 54. The blade 62 is formed at an angle smaller than 90 degrees relative to the bottom surface of the receiving portion 53.

The upper end of the blade 62 is positioned at a point offset in the rotational direction of the blade 62 from the vertical plane passing through the lower end of the blade 62. In other words, the blade 62 may be formed so that it slopes toward the rotation direction of the mixing member 60 as it extends from the bottom to the top. Therefore, when the mixing member 60 rotates, the powdered detergent on the bottom of the first receiving portion 54 can be effectively mixed.

Furthermore, the blade 62 may be formed to be inclined at an angle perpendicular to the extension line of an outlet of the first nozzle 451. Thus, the water sprayed from the first nozzle 451 strikes the front surface of the blade 62 vertically, causing the blade 62 to rotate. Of course, the blade (62) may be formed at an angle that intersects the extension line of the outlet of the first nozzle 451 even if it is not perpendicular to it.

And, the blade 62 may be formed so that the one end contacting the rotating shaft 61 and the other one end 625 far from the rotating shaft 61 have different inclinations. In detail, the one end of the blade 62 contacting the rotating shaft 61 may be inclined at a first angle (α1) with respect to a vertical line passing through the center of the rotating shaft 61. And, the other one end 625 of the blade 62 far from the rotation axis 61 may be inclined at a second angle (α2) with respect to the vertical line. For example, the second angle (α2) may be 550 to 60°. And, the first angle (α1) may be formed at a smaller angle than the second angle (α2).

Accordingly, the blade 62 may be formed to have a shape that is inclined in the direction of rotation as a whole, and may be formed to have a greater incline the farther away it is from the rotating shaft 61. Due to this structure, the detergent may be maintained without being scattered at the end of the blade 62, and may be mixed with the water supplied while in contact with the blade 62. In addition, due to the shape of the blade 62 having a continuous incline structure, the mold for forming the mixing member 60 may be easily separated while rotating. Therefore, it is possible to form a three-dimensional mixing member 60 without using a plurality of mold cores, and it may be possible to perform injection molding without causing a parting line on the blade 62.

Meanwhile, the lower end 624 of the blade 62 may extend in a straight line from the rotation axis 61 to the end of the blade 62. At this time, the lower end of the blade 62 may be formed to have a slope that decreases as it approaches the rotating shaft 61. The slide core 731 that moves radially around the rotating shaft 61 may be made movable by the slope of the lower end of the blade. The third angle (α3) formed by the extension line of the lower end of the rotating shaft 61 and the lower end 624 of the blade 62 may be approximately 3° to 10°.

In addition, a blade recessed portion 626 may be further formed on the upper end of the blade 623. The blade recessed portion 626 may be recessed downward from the upper end of the blade 623. The recessed portion 623 may extend from the rotation axis 61 to one side of the upper end of the blade 623. By the blade recessed portion 626, the blade 62 may be formed to have a larger vertical width on one side farther from the rotation axis 61. In addition, water sprayed from the first nozzle 451 for the rotation of the mixing member 60 may hit one side of the blade 62 with a large vertical width. In addition, mixing of the powdered detergent may be performed by the one side of the blade 62 with a large vertical width. Accordingly, it is possible to have a sufficient area for mixing the powder detergent while reducing the weight of the mixing member 60.

Furthermore, the mixing member 60 may include a ring 63. The ring 63 is formed in a circular shape and may form the edge of the mixing member 60. The ring 63 may connect a plurality of the blades 62 to maintain the overall shape of the mixing member 60. In addition, the ring 63 may connect a plurality of the lower ends 624 of the blades.

The ring 63 functions to minimize vibration and maintain a stable rotational state when the mixing member 60 rotates. In addition, the ring 63 may secure overall strength to maintain its shape along with stable support of the auxiliary blade 64. Furthermore, the powdered detergent mixed between the blades 62 may be guided to gather inside the ring 63.

Since the ring 63 passes over the radial lower edge of the blade 62, the lower edge of the blade 62 is not exposed in a sharp and pointed state. As a result, even if the user touches the blade 62 with his or her hand, the phenomenon of being cut by the blade 62 can be prevented.

The ring 63 extends upward from the lower end of the blade 62 to a predetermined height, and the outer surface of the auxiliary blade 64 and the outer surface of the ring 63 can form a single smooth surface without a step. That is, the rotational trajectory of the auxiliary blade 64 and the ring 63 can be formed into a cylindrical shape having a diameter corresponding to the height of the auxiliary blade 64 and the diameter of the ring 63. In addition, when the mixing member 60 is mounted on the rotating boss 541, the lower surface of the ring 63 can be spaced apart from the bottom of the first receiving portion 54.

Furthermore, auxiliary wings 64 may be formed at the ends of the blades 62. The auxiliary wings 64 may extend along the ring 63 from the ends of the blades 62. Therefore, the water and powder detergent flowing along the blades 62 can be guided to mix inside the mixing member 60 without being scattered outside the mixing member 60.

In detail, the auxiliary blade 64 may be formed on each of the plurality of blades 62. In addition, the auxiliary blade 64 may extend in a direction opposite to the rotational direction of the mixing member 60. That is, the auxiliary blade 64 may protrude in a direction opposite to the rotational direction of the mixing member 60 from one side 621 of both sides of the blade 62 facing the first nozzle 451. Accordingly, when the powdered detergent is scattered by water sprayed from the first nozzle 451, the auxiliary blade 64 can effectively block it from the side.

The auxiliary blade 64 extends along one end 625 of the blade 62 that is far from the rotational axis 61, and can extend upward from the lower end of the blade 62. The auxiliary blade 64 can extend from the blade 62 along the ring 63. That is, the auxiliary blade 64 can extend along the curvature of the ring 63. In addition, the auxiliary blade 64 can protrude from one end 625 of the blade 62 that is far from the rotational axis 61. The auxiliary blade 64 can connect between one end of the blade 62 and the upper end of the ring 63. Therefore, when powdered detergent is scattered in the space between the blades 62, the auxiliary blade 64 can block it from the side.

The extended length of the auxiliary blade 64 may be formed smaller than the gap between the adjacent blades 62. In detail, the length (L1) of the auxiliary blade 64 extending from one side 621 of the blade 62 may be formed smaller than the distance (L2) from the end of the auxiliary blade 64 to the other side 621 of the adjacent blade 62. For example, the length (L1) of the auxiliary blade 64 and the distance (L2) to the other side 621 of the adjacent blade 62 may have a ratio of 1:2.

And, the height (h1) of the auxiliary blade 64 extending upward from the ring 63 may be formed lower than the height (h2) from the ring 63 to the top of the blade 623. For example, the height (h1) of the auxiliary blade 64 and the height (h2) from the ring 63 to the top of the blade 623 may have a ratio of 1:2.

The auxiliary blade 64 may be formed to extend from the ring 63 at the same height. And, the auxiliary blade (64) may be formed lower than the top of the blade 62.

Meanwhile, the height (H2) of the auxiliary blade 64 based on the lower end 264 of the blade 62 can be formed to be the same as the height (H1) of the upper end of the blade 62 connected to the rotating shaft 61.

Accordingly, if the position of the dividing line (see FIG. 28 L) of the core (see FIG. 28 731, 74) of the upper and lower separable mold device (see FIG. 28 70) corresponds to the height (H2) of the auxiliary blade and the height (H1) of the upper end of the blade 62 connected to the rotating shaft 61, exhaust for removing the air trap can be possible at that position.

That is, by forming a rotating shaft groove 613 on the rotating shaft 61, the flow of the resin injected during injection molding of the mixing member 60 is improved, and the position of the air trap where the resin meets is guided toward the dividing line, thereby eliminating the air trap.

The size of the auxiliary blade 64 should be sufficient to block the powder detergent flowing outward or flying along the blade 62. If the length of the auxiliary blade 64 is excessively large, the water flow inside the first receiving portion 54 is not good, and the weight of the mixing member 60 may become heavy, which may reduce the rotational motion

In addition, the auxiliary blade 64 may be formed to form an acute angle that is vertical or slightly inclined toward the rotating shaft 61 based on the bottom surface of the first receiving portion 54. That is, the auxiliary blade 64 may be inclined toward the rotating shaft 61 as it extends upward from the bottom. Therefore, the powder detergent flowing along the blade 62 or colliding with the auxiliary blade 64 may be guided back to the inner area of the ring 63.

Meanwhile, the auxiliary blade 64 may be formed so that the end of the auxiliary blade 64 is inclined in the rotational direction of the blade 62, that is, in the direction in which the blade 62 is inclined. In detail, one side 621 of the blade 62 and the upper end of the auxiliary blade 64 may be formed at a first set angle (β1). At this time, the first set angle (β1) may be an obtuse angle. In addition, the lower end of the auxiliary blade 64 and the ring 63 may be formed at a second set angle (β2). At this time, the second set angle (β2) may be formed larger than the first set angle (β1).

Accordingly, the rotating core (74: see FIG. 28) can be separated from the mixing member 60 while rotating during injection molding of the mixing member 60 due to the inclined shape of the blade 62 and auxiliary blade 64. In addition, the mixing member 60 can have a structure that allows molding of the blade 62 and the auxiliary blade 64 without using a plurality of cores.

The auxiliary blade 64 may extend upward from the upper surface of the ring 63 to a predetermined height. For example, the auxiliary blade 64 may extend to a point corresponding to half of the length from the upper to the lower end of the blade 62.

The auxiliary blade 64 includes an upper surface 641 and a side surface 642. The side surface 642 refers to a circumferential end of the auxiliary blade 64 and may be formed to be inclined in the same direction as the inclination direction of the radial end of the blade 62. In addition, an edge where the upper surface and the lower surface of the auxiliary blade 64 meet may be smoothly curved at a predetermined curvature. At least one of an edge where the side surface of the auxiliary blade 64 and the upper surface of the ring 63 meet and an edge where the upper surface of the auxiliary blade 64 and the blade 62 meet may be formed to be rounded.

Hereinafter, with reference to the drawings, a mold device 70 for a laundry machine detergent supply device according to an embodiment of the present invention will be described in more detail.

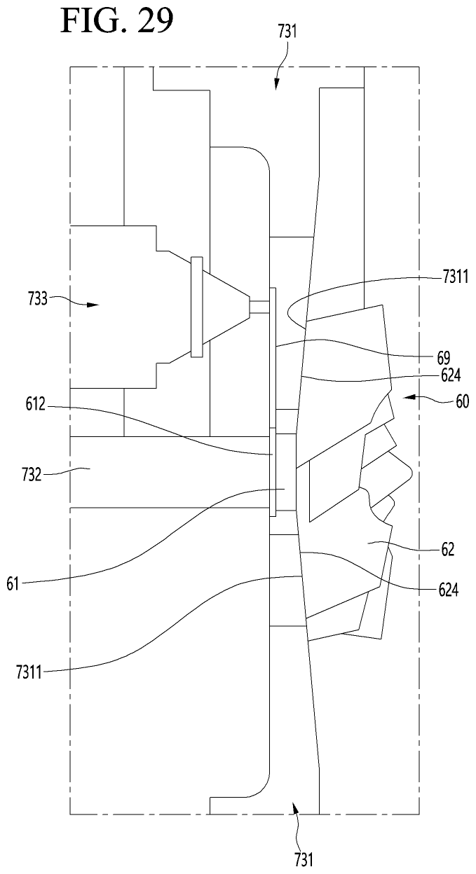

FIG. 28 is a schematic drawing of a mold device for forming the mixed member. And, FIG. 29 is a drawing showing the arrangement of nozzles and gates for injection of the mixed member.

As illustrated, the mold device 70 according to an embodiment of the present invention may include a fixed side 71 that maintains a fixed state and a moving side 72 that moves in an up-and-down direction (left-right direction in FIG. 28) based on the fixed side 71.

The fixed side 71 may be maintained in a fixed state and may include a first fixed body 711 in which a slide core 731, a vertical movement core 732, and an injection nozzle 733 are mounted, and a second fixed body 712 provided within the first fixed body 711 and moving the vertical movement core 732. The fixed side 71 may further be provided with an actuator 735 for operating the vertical movement core 732.

And, the moving side 72 may optionally come into contact with the first fixed body 711, and may include a first moving body 721 in which a rotation core 74 is accommodated, and a second moving body 722 in which the rotation core 74 is fixedly mounted.

When the mold device 70 is closed, the mixing member 60 may be molded. At this time, the first fixed body 711 and the first moving body 721 may be in a state of contact with each other, and may be separated from each other when the moving side 72 moves. Therefore, the boundary where the first fixed body 711 and the first moving body 712 meet may be defined as the dividing line. And, the slide core 731 may be in a state of being moved toward the rotating shaft 61. And the vertical moving core 732 may be in a state of being inserted into the rotating shaft 61. Since the vertical moving core 732 is in a downwardly moved state, the second fixed body 712 may also be in a downwardly moved state. In addition, the rotation core 74 may be in a state of contacting the blade 62 and the auxiliary blade 64 while being moved downward to the maximum extent.

In this state, when resin is injected from the injection nozzle 733, the resin is injected through the injection gate 69, and the mixing member 60 can be molded by the slide core 731, the vertical moving core 732, and the rotation core 74.

Meanwhile, the blade forming part 741 provided on the rotation core 74 can extend from the upper end of the rotating shaft 61 to the end of the blade 62 and auxiliary blade 64.

After the injection of the resin, when the mixing member 60 is formed, the moving side 72 can move upward. At this time, the first moving body 721 maintains a state of contact with the first fixed body 711, and only the second moving body 722 to which the rotation core 74 is fixed can move upward.

The rotation core 74 moves together with the upward movement of the second moving body 722. And, it can rotate simultaneously with the upward movement of the second moving body 722. The rotation direction of the rotation core 74 can be the same as the inclination direction of the blade 62 and the auxiliary blade 64.

Therefore, during the upward separation process of the moving side 72, the rotation core 74 rotates in the same direction as the rotation direction of the blade 62 and the auxiliary blade 64, so that the blade 62 and the auxiliary blade 64 can be formed at once.

The moving side 72 moves further upward after the rotation and movement of the rotation core 74, and first moving body 721 can be separated from the first fixed body 711.

And, the slide core 731 arranged on the fixed side 71 can move away from the rotating shaft 61. The slide cores 731 can be arranged in multiples at equal angles around the rotating shaft 61 and can selectively come into contact with each other. For example, three slide cores 731 can be arranged at 1200 angles each.

By the movement of the slide core 731, the slide cores 731 can be separated from each other in a contact state. In addition, when the slide core 731 moves, the inclined portion 7311 of the slide core 731 moves along the incline of the lower end of the blade 624 and is separated from the mixing member 60. When the movement of the slide core 731 is completed, the mixing member 60 can be separated from the slide core 731.

In addition, the vertical moving core 732 may be inserted into the inside of the rotating shaft 61, and thus may form the internal shape of the rotating shaft 61 while supporting the mixing member 60 separated from the slide core 731.

Meanwhile, the injection nozzle 733 may be placed below the slide core 731. The injection nozzle 733 may be provided between the neighboring slide cores 731. In addition, the injection gate 69 connected to the protrusion 612 of the rotation shaft 61 at the upper end of the injection nozzle 733 may also be positioned at the boundary of the neighboring slide cores 731 to minimize interference with the slide cores 731. In addition, when the slide cores 731 are moved apart from each other, the injection gate 69 may be positioned between the slide cores 731.

As illustrated, when the molding of the mixing member 60 is completed, the vertical moving core 732 can be moved upward by the movement of the second fixed body 712. By the upward movement of the vertical moving core 732, the mixing member 60 is moved upward and can be completely moved from the slide core 731. At this time, the injection gate 69 can be moved upward without interfering with the slide core 731 while being attached to the mixing member 60.

And, by the operation of the actuator 735, the rotational shaft core 736 inside the vertical movement core 732 moves backward, and the inside of the rotating shaft 61 and the rotational shaft core 736 can be completely separated. Therefore, the mixing member 60 can be in a form in which the lower end of the rotating shaft 61 is secured to the end of the vertical movement core 732, and the worker can separate the mixing member 60 from the vertical movement core 732. The injection gate 69 can be removed after separating the mixing member 60 from the vertical movement core 732.

The molding of the mixing member 60 can be completed by this process.

In the following, the water flow state of the detergent supply device 20 having the above structure is described in detail with reference to the drawings.

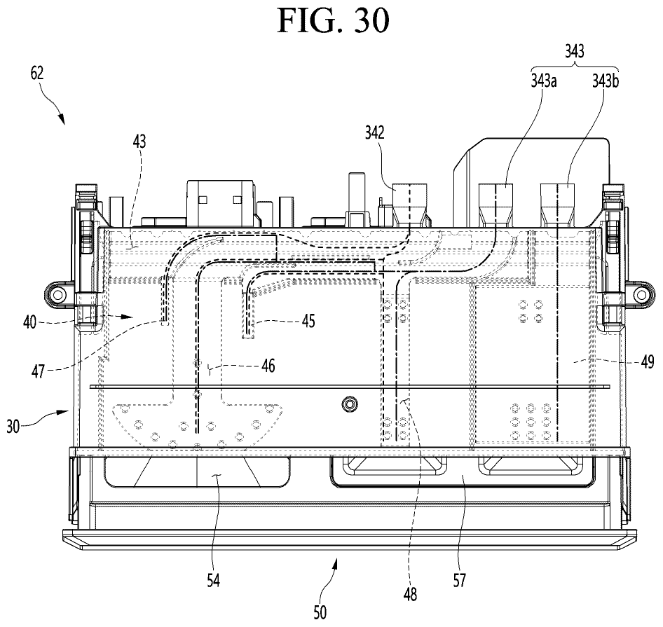

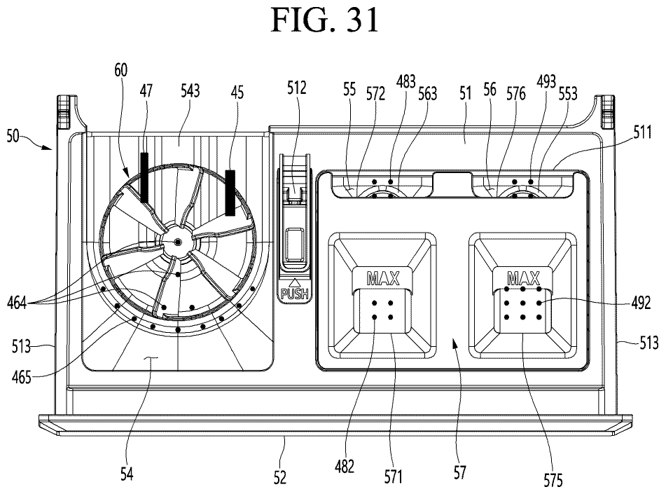

FIG. 30 is a drawing showing the flow path of the washing water supplied by the detergent supply device, and FIG. 31 is a drawing showing the arrangement of the water supply ports connected to each receiving portion of the drawer.

Referring to FIGS. 30 to 31, water supply to the interior of the housing 30 begins according to the operation of the water supply device 15. That is, depending on the selective operation of the valve 153, 154, water can be supplied to the hot water port 342 and the cold water port 343. At this time, the cold water supplied to the second cold water port 343b is directly supplied only to the fifth discharge path 49 through the additional distribution path and can be supplied to the third receiving portion.

The water supplied to the hot water port 342 and the first cold water port 343a flows into the distribution path 43. The hot water flowing into the hot water port 342 and the cold water flowing into the first cold water port 343a are mixed within the distribution path 43 and can be guided to the discharge path 44 while flowing along the distribution path 43.

Washing water supplied through the first cold water port 343a and the hot water port 342 flows along the distribution path 43, and can be distributed by a plurality of guide ribs 430 and guided to a plurality of discharge paths 45, 46, 47, 48.

Washing water flowing through the distribution path 43 into the first discharge path 45 can be supplied to the first receiving portion 54 through the first discharge path 45. Washing water flowing along the first discharge path 45 can be sprayed from the first nozzle 451 and hit one side 621 of the blade 62 to rotate the mixing member 60.

And, some of the washing water flowing into the second discharge path 46 through the distribution path 43 is supplied to the first receiving portion 54 through the second discharge path 46. The washing water supplied through the second discharge path 46 can be supplied to the inner surface of the first receiving portion 54 through the first shower hole 463. And, it can also be supplied to the mixing member 60 through the first shower hole 463.

And, some of the washing water flowing into the third discharge path 47 through the distribution path 43 may flow into the third discharge path 47 and be supplied to the first receiving portion 54 through the third discharge path 47. And, the washing water flowing along the third discharge path 47 may be sprayed from the second nozzle 471 to wash the rear surface of the blade 62.

And, some of the washing water flowing into the fourth discharge path 48 through the distribution path 43 flows into the fourth discharge path 48, is discharged through the second shower hole 482, 483 of the fourth discharge path 48, and can be supplied to the second receiving portion 55 through the first cover hole 571, 572 of the cover 57.

And, some of the washing water flowing into the fifth discharge path 49 through the distribution path 43 flows into the fifth discharge path 49, is discharged through the third shower hole 492, 493 of the fifth discharge path 49, and can be supplied to the third receiving portion 56 through the first cover hole 571, 572 of the cover 57.

Hereinafter, the behavior of the washing water supplied from the flow path member 40 to each receiving portion is described in more detail with reference to the drawings.

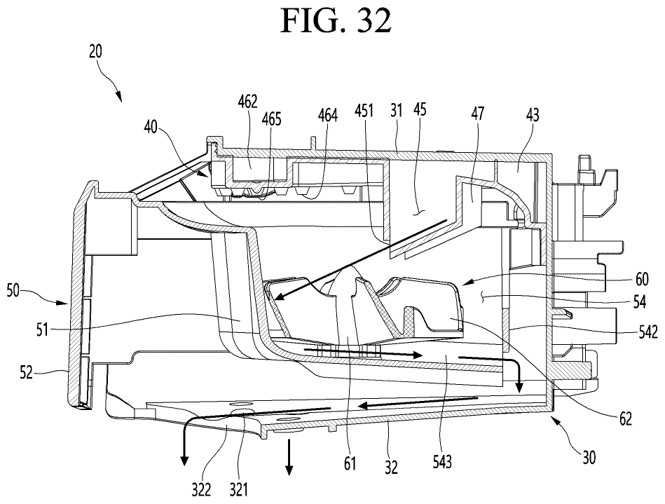

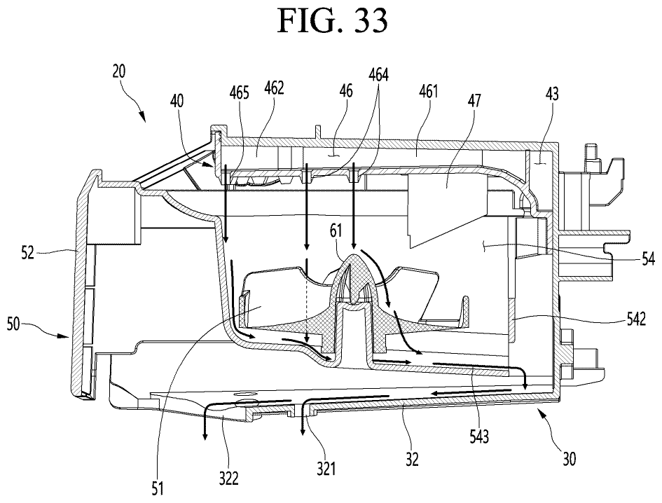

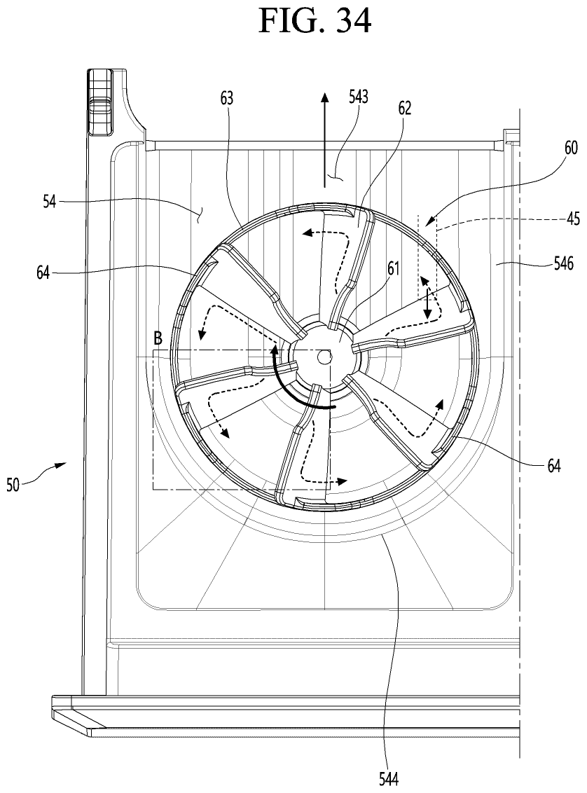

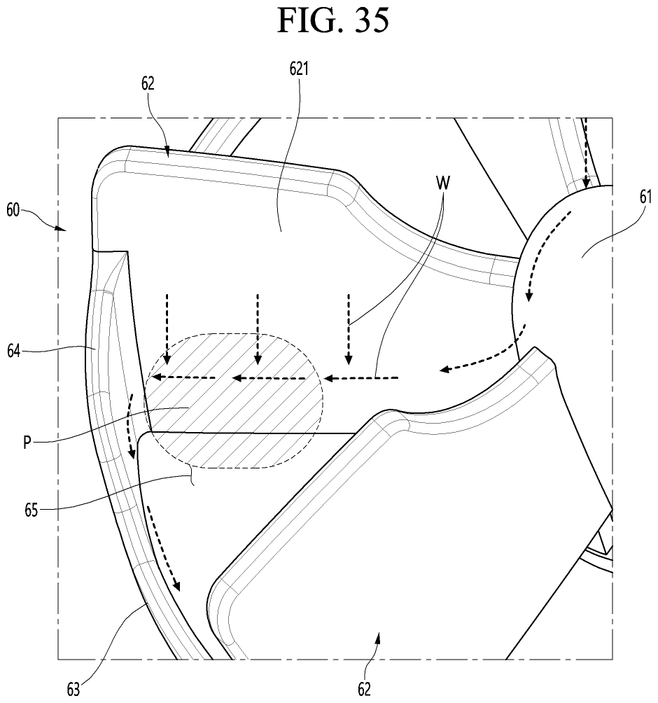

FIG. 32 is a drawing showing the washing water being sprayed into the mixing member through the nozzle of the path member, FIG. 33 is a drawing showing the washing water falling into the first receiving portion through the first shower hole of the path member, FIG. 34 is a perspective view showing the flow of detergent inside the receiving portion, and FIG. 35 is an enlarged view of part B of FIG. 34.

Referring to FIGS. 32 to 35, the water flowing along the first discharge flow path 45 flows along the downwardly inclined bottom surface of the first discharge flow path 45 and is sprayed onto a surface of the blade 62 through the first nozzle 451 formed at the front lower end of the first discharge flow path 45.

The bottom portion of the first discharge path 45 may be inclined and extended in a direction intersecting with a surface, namely the front surface, of the blade 62. Therefore, the water sprayed from the first nozzle 451 strikes the front surface of the blade, causing the mixing member 60 to rotate. The angle α formed between the washing water sprayed from the first nozzle 451 and the front surface of the blade 62, i.e., the discharge angle of the washing water sprayed from the first nozzle 451, is 90 degrees, thereby maximizing the rotational force of the mixing member 60.

Furthermore, as the first nozzle 451 moves closer to the edge of the blade 62 than the rotation axis 61 of the mixing member 60, the rotational moment of the mixing member 60 increases. Therefore, the formation position of the first discharge passage 45 can be appropriately selected according to the design conditions.

Furthermore, while water is sprayed from the first nozzle 451, the mixing member 60 can continue to rotate. The first receiving portion 54 is filled with powdered detergent, and as the mixing member 60 rotates, it mixes the powdered detergent with water to dissolve the powdered detergent in the washing water. The powdered detergent, which may be unevenly distributed or in a lumped state within the first receiving part 54, may be crushed by the mixing member 60, dissolved in water, and then discharged toward the rear of the drawer 50.

In detail, as shown in Figure. 31 and Figure. 32, the mixing member 60 is rotated by water sprayed from the first nozzle 451. Then, when the mixing member 60 rotates, the water supplied by the first nozzle 451 and the first shower hole 463 can be mixed with the powdered detergent filled in the first receiving portion 54.

By centrifugal force resulting from the rotation of the mixing member 60, the powdered detergent (P) adjacent to the blade 62 moves along the blade 62 in the circumferential direction of the mixing member 60. In addition, the powdered detergent (P) placed on the blade 62 can be scattered by the pressure of the water sprayed from the first nozzle 451.

At this time, since the auxiliary blade 64 extends in the direction opposite to the rotational direction of the mixing member 60, the powdered detergent (P) moving in the circumferential direction along the blade 62 and the powdered detergent (P) flying by the sprayed water can be guided to the inner region of the mixing member 60 rather than going outside the mixing member 60.

Accordingly, the powder detergent inside the first receiving portion 54 is prevented from leaking out of the first receiving portion 54, so that the drawer 50 can be kept clean. In addition, since the powder detergent (P) is continuously guided into the space between the blades 62, it can be effectively crushed by the rotating blades 62 and the water sprayed from the first nozzle 451, and can be completely dissolved in the wash water.

And, when the mixing member 60 rotates, the blade 62 and the auxiliary blade 64 can pass through the drainage groove 543. Therefore, the dissolved powder detergent positioned between the plurality of blades 62 can naturally flow into the drainage groove 543 and can be discharged to the rear of the first receiving portion 54 through the drainage groove 543.

Furthermore, the dissolved detergent discharged to the rear of the drawer 50 can be discharged into the tub 11 through the housing discharge port 321 of the housing lower surface 32 and the front end of the housing lower surface 32.

Furthermore, the washing water flowing along the second discharge path 46 passes through the main portion 461 and proceeds toward the extended portion 462. Furthermore, the washing water falling into the first receiving portion 54 through the first shower hole 463 of the second discharge path 46 can clean the interior of the first receiving portion 54 and the mixing member 60.

In detail, a portion of the washing water passing through the main portion 461 can fall downward through a plurality of main shower holes 464 and be supplied to the mixing member 60. The mixing member 60 can be cleaned by the water falling from the main shower holes 464.

Some of the main shower holes 464 may be located vertically above the rotating shaft 61. Therefore, the detergent adhering to the surface of the rotating shaft 61 may be washed off by the water falling from the main shower holes 464. Furthermore, some of the main shower holes 464 may be located vertically above the blade 62. Therefore, the detergent adhering to the blade 62 can be washed away by the water falling from the main shower holes 464.

The washing water flowing through the main portion 461 into the extended portion 462 fills the extended portion 462 and falls downward through a plurality of extended shower holes 465 to clean the first receiving portion 54. In detail, the extended shower holes 465 may be located vertically above the rounded front of the first receiving portion 54. In particular, the extended shower holes 465 may be arranged along the front edge of the first receiving portion 54.

Therefore, the washing water falling from the extended shower hole 465 can fall onto the upper part of the front surface of the first receiving portion 54 or onto the surface forming the front surface of the first receiving portion 54. Furthermore, the washing water falling from the extended shower hole 465 flows along the front surface of the first receiving portion 54 and flows rearward along the inclined bottom surface of the first receiving portion 54. Therefore, the detergent adhering to the inner surface of the first receiving portion 54 can be washed off by the washing water falling from the extended shower hole 465.

Furthermore, the water used to wash the first receiving portion 54 can be discharged to the rear of the drawer 50 together with the detergent. Furthermore, the water and detergent discharged to the rear of the drawer 50 can be discharged into the tub 11 through the housing discharge port 321 and the front portion of the housing lower surface 32.

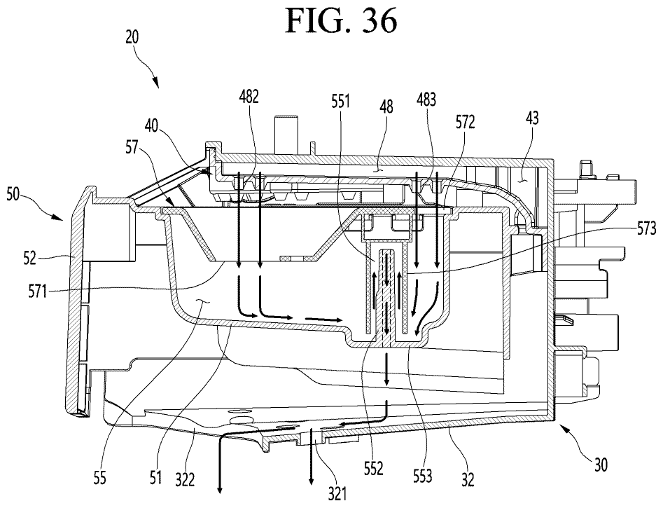

FIG. 36 is a drawing showing the washing water falling into the second receiving portion through the second shower hole formed in the path member.

Referring to FIGS. 31 and 36, the water entering the fourth discharge path 48 flows forward along the fourth discharge path 48 and can be supplied to the second receiving portion 55 through the second shower hole 481 formed in the fourth discharge path 48.

For example, liquid detergent can be contained in the second receiving portion 55, and after being diluted by the washing water supplied from the second shower hole 481, it can be discharged to the bottom of the housing 30 through the siphon boss 551.

In detail, a portion of the washing water flowing along the fourth discharge path 48 falls downward from the first front hole 482. At this time, the first front hole 482 passes through the first front cover hole 571 of the receiving portion cover 57 and falls toward the front of the second receiving portion 55. It can then be mixed with liquid detergent inside the second receiving portion 55.

Additionally, another portion of the washing water flowing along the fourth discharge path 48 falls downward through the first rear hole 483. At this time, the washing water falling through the first rear hole 483 passes through the first rear cover hole 572 of the receiving portion cover 57 and falls toward the rear of the second receiving portion 55.

The first rear hole 483, the first rear cover hole 572, and part of the siphon recess 553 may overlap in the vertical direction. Therefore, water falling from the first rear hole 483 can pass through the first rear cover hole 572 and fall directly into the siphon recess 553. Therefore, high-viscosity liquid detergent or solidified liquid detergent accumulated in the siphon recess 553 can be melted or crushed, thereby making it easier to discharge via the siphon effect.

The liquid detergent mixed with the water supplied to the second receiving portion 55 flows along the space between the siphon extension 573 and the siphon boss 551 from the siphon recess 553, enters the opening at the top of the siphon boss 551 and is discharged below the drawer 50. Furthermore, the liquid detergent mixed with water discharged below the drawer 50 can be discharged into the tub 11 through the housing discharge port 321 and the front end of the housing lower surface.

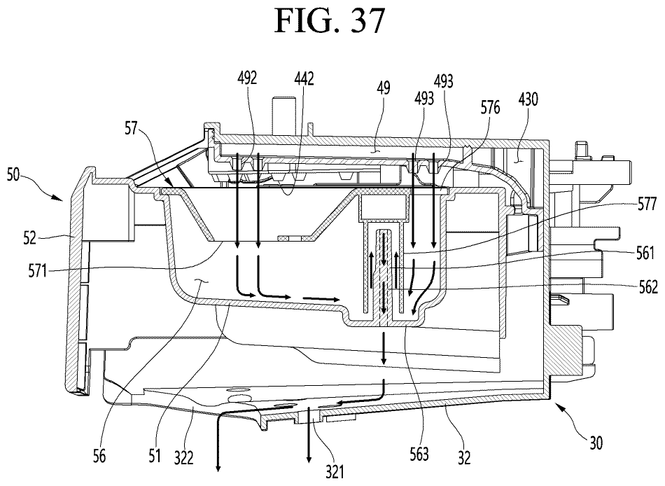

FIG. 37 is a drawing showing the washing water falling into the third receiving portion through the third shower hole formed in the path member.

Referring to FIGS. 31 and 37, the water entering the fifth discharge path 49 flows forward along the fifth discharge path 49 and can be supplied to the third receiving portion 56 through the third shower hole 491 formed in the fifth discharge path 49.

For example, the third receiving portion 56 may contain fabric softener, which can be diluted by the washing water supplied from the third shower hole 491 and discharged downward through the siphon boss 561.

In detail, a portion of the washing water flowing along the fifth discharge path 49 falls downward from the second front hole 492. At this time, the washing water falling from the second front hole 492 passes through the second front cover hole 575 of the receiving cover 57 and falls in front of the third receiving portion 56. The washing water falling into the third receiving portion 56 can be mixed with fabric softener.

The remaining portion of the washing water flowing along the fifth discharge path 49 falls downward through the second rear hole 493. At this time, the washing water falling from the second rear hole 493 passes through the second rear cover hole 576 of the receiving portion cover 57 and falls to the rear of the third receiving portion 56.

The second rear hole 493, the second rear cover hole 576, and part of the siphon recess 563 may overlap in the vertical direction. Therefore, water falling from the second rear hole 493 can pass through the second rear cover hole 576 and fall directly into the siphon recess 563. Therefore, high-viscosity liquid detergent or solidified liquid detergent accumulated in the siphon recess 563 can be melted or crushed, thereby making it easier to discharge via the siphon action.

The fabric softener mixed with the water supplied to the third receiving portion 56 flows along the space between the siphon extension 577 and the siphon boss 561 from the siphon recess 563, enters the opening at the top of the siphon boss 561, and can be discharged below the drawer 50. Furthermore, the fabric softener mixed with water discharged below the drawer 50 can be discharged into the tub 11 through the housing discharge port 321 and the front end of the housing lower surface 32.

In another aspect, a laundry machine according to an embodiment of the present invention may comprise: a cabinet; a tub rotatably arranged inside the cabinet; and a detergent supply device provided in the cabinet and supplying washing water and detergent to the tub, wherein the detergent supply device comprises: a drawer arranged to be withdrawably and having a recessed receiving portion formed to receive detergent; and a mixing member rotatably arranged in the receiving portion to mix the washing water and the detergent, wherein the mixing member comprises: a rotating shaft defining the center of rotation of the mixing member, with the lower surface opened and a rotating boss formed in the receiving portion inserted therein; having an open lower surface, into which a rotating boss formed in the receiving portion is inserted to serve as a center of rotation of the mixing member; a plurality of blades extending radially from the rotating shaft; and a plurality of rotating shaft grooves extending upward from a lower end of the rotating shaft may be formed on an inner surface of the rotating shaft.

The rotating shaft grooves may be arranged radially based on the center of the rotating shaft.

The rotating shaft grooves may be arranged at equal intervals.

The rotating shaft grooves may be arranged symmetrically with respect to the center of the rotating shaft.

The rotating shaft may be formed in a shape in which the inner diameter becomes narrower as it extends from the bottom to the top, and the rotating shaft groove may be formed in a width that becomes narrower as it extends upward along the inner surface of the rotating shaft.

A support portion that protrudes downward and is seated on the top of the rotating boss is formed on the inner upper side of the rotating shaft, and the rotating shaft groove may be arranged symmetrically with respect to the support portion.

A protrusion that protrudes outward is formed on the lower side of the rotating shaft, and the rotating shaft groove extends upward from the protrusion, and the protrusion may be connected to an injection gate for molding the mixing member.

The mixing member may include an auxiliary blade that extends in a direction intersecting the blade from an extended end of the blade.

The mixing member may be formed so that the height of the upper part of the auxiliary blade is the same as the height of the upper part of the blade connected to the rotating shaft.

The position of the upper part of the blade connected to the rotating shaft can correspond to the dividing line of the mold that moves up and down for forming the mixing member.

In the laundry machine according to the above embodiment, the following effects can be expected. In the laundry machine according to the embodiment of the present invention, a rotating shaft groove can be formed at an end of the rotating shaft to improve the flow of resin during injection molding. The rotating shaft grooves are formed in multiple numbers along the rotating shaft to improve the flow of resin injected into the rotating shaft, and the location of an air trap generated during molding can be moved to a dividing line where the mold is separated, so that the air trap can be removed through exhaust. Therefore, the appearance of the mixing member can be prevented from being poor due to the air trap, and the detergent can be prevented from remaining at the mixing member.

In another aspect, a laundry machine according to an embodiment of the present invention may comprise: a cabinet; a tub rotatably arranged inside the cabinet; and a detergent supply device provided in the cabinet and supplying detergent to the tub; wherein the detergent supply device comprises: a housing mounted to the cabinet and connected to a water supply device; a drawer withdrawably mounted in the housing and having a receiving portion for receiving detergent sunken downward; a mixing member rotatably arranged in the receiving portion and mixing the detergent inside the receiving portion; and a path member coupled to the housing above the drawer and forming a path for supplying water supplied from the water supply device to the drawer, wherein the mixing member comprises: a rotating shaft, a plurality of blades extending radially from an outer surface of the rotating shaft, and a circular ring connecting lower edges of the plurality of blades.

The rotating shaft may be formed in a form in which the diameter decreases from the bottom to the top, and the shaft support portion may extend downwardly from the inner top by a predetermined length.

The shaft support portion may include a support protrusion extending from the inner top of the rotating shaft, and a support base formed on the outer surface of the support protrusion.

The support base may include a plurality of support ribs connecting the outer surface of the support protrusion and the inner surface of the support shaft, and the plurality of support ribs may be arranged spaced apart from each other in the circumferential direction.

The mixing member further includes a plurality of auxiliary blades extending along the ring in the circumferential direction by a predetermined length from the ends of the plurality of blades.

Each of the plurality of auxiliary blades is characterized in that it extends upwardly from the upper surface of the ring along the ends of the blades by a predetermined height, and the upper surface of the auxiliary blade is located at a point lower than the upper surface of the blade.

The blade may be formed to be inclined at a predetermined angle in the direction of rotation of the rotating shaft as it goes upward, and the side surface of the auxiliary blade may be inclined at an angle corresponding to the inclination angle of the blade.

At least one of the corner where the upper surface and the side surface of the auxiliary blade meet, the corner where the side surface of the auxiliary blade meet the upper surface of the ring, or the corner where the upper surface of the auxiliary blade meet the blade may be formed to be rounded.

In the laundry machine according to the proposed embodiment, the following effects can be expected. In the laundry machine according to the embodiment of the present invention, since a ring connecting the lower end of the blade is formed, the sharp lower edge of the blade is removed to form an acute angle, thereby preventing the user from being injured.

What is claimed is:

1. A laundry machine, comprising:
a cabinet;
a tub rotatably disposed inside the cabinet; and
a detergent supply device provided in the cabinet and supplying detergent to the tub,
wherein the detergent supply device comprises:
a housing mounted to the cabinet and connected to a water supply device;
a drawer withdrawably mounted in the housing and having a receiving portion recessed for receiving the detergent; and
a mixing member rotatably disposed in the receiving portion for mixing the detergent and eater,
wherein the mixing member comprises:
a rotating shaft that is the center of rotation of the mixing member;
a plurality of blades extending radially from the rotating shaft; and
an auxiliary blade extending from an end of the blade in a direction intersecting the blade.

2. The laundry machine according to claim 1, wherein the auxiliary blades are formed on each of the blade.

3. The laundry machine according to claim 1, wherein the auxiliary blade extends in a direction opposite to the rotational direction of the mixing member.

4. The laundry machine according to claim 3, wherein the auxiliary blade extends in the circumferential direction of the mixing member.

5. The laundry machine according to claim 1, wherein the auxiliary blade extends along one end of the blade far from the rotation axis and extends upward from the lower end of the blade.

6. The laundry machine according to claim 5, wherein the auxiliary blade is formed to be vertical or at an acute angle with respect to the bottom surface of the receiving portion.

7. The laundry machine according to claim 1, wherein the mixing member includes a ring connecting the extended ends of the plurality of blades.

8. The laundry machine according to claim 7, wherein the ring connects the lower ends of the plurality of blades, and the auxiliary blade extends from the blades along the ring.

9. The laundry machine according to claim 7, wherein the auxiliary blade connects between one end of the blade farthest from the rotation axis and the upper end of the ring.

10. The laundry machine according to claim 9, wherein the auxiliary blade is formed lower than the upper end of the blade.

11. The laundry machine according to claim 10, wherein the auxiliary blades extend from the ring at the same height.

12. The laundry machine according to claim 1, wherein the extended length of the auxiliary blade is formed smaller than the gap between the adjacent blades.

13. The laundry machine according to claim 1, wherein a nozzle is provided on the inside of the housing to spray water supplied from the water supply device toward the blade to rotate the mixing member.

14. The laundry machine according to claim 13, wherein the blade is formed to be inclined in the direction of rotation of the blade, so that an extension of the outlet of the nozzle and a surface of the blade intersect each other.

15. The laundry machine according to claim 14, wherein a first set angle is formed between the surface of the blade and the upper end of the auxiliary blade, and the first set angle is an obtuse angle.

16. The laundry machine according to claim 15, wherein the mixing member includes a ring connecting the extended ends of the plurality of blades, and
the lower portion of the auxiliary blade and the ring are formed at a second set angle, and the second set angle is formed to be greater than the first set angle.

17. The laundry machine according to claim 1, wherein the receiving portion comprises:
a round portion formed in a shape corresponding to the outer diameter of the mixing member and forming the front part of the receiving portion; and
a side portion extending from both sides of the round portion to the rear end of the drawer and forming both sides of the receiving portion, and
wherein the rear side of the receiving portion is opened to the rear of the drawer.

18. The laundry machine according to claim 17, wherein a drainage groove is formed on the bottom of the receiving portion, extending to the rear end of the drawer, through which the detergent of the receiving portion is discharged, and
a rotating boss protruding upward is provided on the inside of the drainage groove so that the rotating shaft can be rotatably installed.

19. The laundry machine according to claim 18, wherein the lower end of the rotating shaft extends downwards further than the lower end of the blade and is accommodated inside the drainage groove, and
the blade is positioned above the drainage groove.

20. The laundry machine according to claim 19, wherein the blade and the auxiliary blade pass through the drainage groove when the mixing member rotates.
